(19) United States
(12) Patent Application Publication
(10) Pub. No.: US 2008/0320053 A1
(43) Pub. Date: Dec. 25, 2008

(54) DATA MANAGEMENT METHOD FOR ACCESSING DATA STORAGE AREA BASED ON CHARACTERISTIC OF STORED DATA

(76) Inventors: Michio IIjima, Tokyo (JP); Yukio Nakano, Oyama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/041,299

(22) Filed: Mar. 3, 2008

(30) Foreign Application Priority Data
Jun. 21, 2007 (JP) 2007-163675
Dec. 13, 2007 (JP) 2007-321768

(51) Int. Cl. G06F 17/30

(52) U.S. Cl. 707/201; 707/E17.005

(57) ABSTRACT

There is provided a data management method for managing data stored in a parallel database system in which a plurality of data servers manage data. The parallel database system manages: correspondence information between a characteristic of the data and each of the plurality of data servers that manages the data; and a data area corresponding to the characteristic of the data. The data management method comprising the steps of: extracting the characteristic of the data from data to be stored in the data area; storing the data in the data area based on the extracted characteristic of the data; specifying a corresponding data area based on the characteristic of the data stored in the data area by referring to the correspondence information; and accessing, by each of the plurality of data servers, the specified data area.

### CLAIM OF PRIORITY

The present application claims priority from Japanese patent applications JP 2007-163675 filed on Jun. 21, 2007, and JP 2007-321768 filed on Dec. 13, 2007, the content of which are hereby incorporated by reference into this application.

### BACKGROUND OF THE INVENTION

This invention relates to a technique of distributing data in a parallel database system for managing data in a dispersed manner.

A parallel database can divide a data storage destination (hereinafter, referred to as “data server”) into a plurality of data servers in management of large-volume data. By distributing data into respective data servers to reduce a data amount of data managed by each data server, performance of the parallel database can be improved as a whole.

A database administrator can operate the parallel database with ease by classifying management subject data based on predetermined conditions and storing the data in respective data servers when the data is to be distributed to the respective data servers. For example, in a system structure including four data servers A to D, which store data created by A to D departments, respectively, it is possible to limit a backup destination of the data created by the A department to the data server A.

On the other hand, if the data is stored randomly in the respective data servers, even the backup of the data created by the A department may exert an adverse influence such as a quiescence of the entire system or a decrease in response.

Such a system structure in which management subject data is classified and stored in respective data servers can be improved in operability by being divided into a system (original management system) for positively archiving data and a system (data utilization system) for utilizing the archived data for an application.

In the above-mentioned operation, a high-level backup processing such as a disaster recovery is executed on the original management system. If there exists the need for restructuring the system in a case of a disaster, a large-scale service interruption, a replacement of the system, or the like, the system is restructured after the data is distributed from the original management system to data utilization system.

Further, in a case of classifying data to be managed by respective data servers in a data parallel database, characteristics or contents of subject data need to be grasped when the data is distributed to the respective data servers. In that case, the subject data is analyzed to grasp the characteristics of the subject data before distribution thereof, and the subject data is distributed to the respective data servers based on the grasped characteristics. For example, four-byte information starting from the fifth byte of the distribution subject data is extracted and converted into a four-byte integer value, and the subject data is distributed to the data server A if the value is 1, the data server B if 2, the data server C if 3, and the data server D if 4.

Further, the respective data servers have corresponding data storage areas separate from one another and occupy their own data storage areas, thereby realizing a high-speed storage processing without execution of an exclusive processing or the like. JP 2006-11786 A discloses a method of automatically setting storage areas on a shared disk as a method of deciding sizes of areas occupied by respective data servers in such a system structure as described above.

The conventional parallel database has such specifications as to store only data in a predetermined format, which allows high-speed processings. For example, the format of registered data is strictly defined with 4 bytes at the head of the data representing an identifier thereof, the subsequent 4 bytes representing information on an access level, the subsequent 256 bytes representing a data name, the subsequent 4 bytes representing pointer information, and the like. At the time of storage, the data is analyzed based on the defined format to acquire values of respective items. Therefore, analyzing the subject data before its distribution to grasp the characteristics or contents thereof requires the subject data to be analyzed twice during the processings from distribution to storage.

However, there is no practical problem if the time required for the analysis of the subject data, which is in a regular format, is much shorter than the time required for the distribution itself. For example, in a case where a transfer speed expected as an overhead is 100 Mbps, if the time required for the analysis is shorter than that required for the distribution with the throughput bottleneck being the transfer speed, the distribution of 4-terabyte data is completed in approximately 11 hours (half a day).

### SUMMARY OF THE INVENTION

On the other hand, if the distribution subject data is a structured document, the processing cannot be executed in the same manner. Examples of the structured document include a document described in an extensible markup language (XML) (hereinafter, referred to as “XML document”).

In the structured document, locations of items used for classification within a document may not be fixed, so the document itself needs to be analyzed. Therefore, the analysis of the structured document requires more processing cost than extraction of data from the regular-format data. For example, if the analysis of one XML document requires 9 milliseconds, it takes approximately 1000 hours (42 days) to distribute the 4-terabyte data (400 million 10-kilobyte XML documents).

It is possible to reduce the time required for the analysis by providing a plurality of servers dedicated for analyzing the distribution subject data (parse servers) before the distribution and performing a parallel processing. However, because the parse server is not used after once structuring a database, securing a plurality of parse serves is not a practical solution in terms of the cost thereof.

In addition, such a problem relating to the time required for the data analysis processing could not be solved by the method of automatically setting storage areas on a shared disk disclosed in JP 2006-11786 A.

This invention has been made in order to provide a technique which allows a parallel database including a plurality of storage destinations (data servers) to structure a database in such a time as to cause no practical problem from a large volume of data without the need for an analysis-dedicated server (parse server) in a case where data imposing a heavy load on its analysis processing is managed by a specific data server based on a characteristic or a content of the data.

A representative aspect of this invention is as follows. That is, there is provided a data management method for managing data stored in a parallel database system in which a plurality of data servers manage data. The parallel database system manages: correspondence information between a characteristic of the data and each of the plurality of data servers that manages the data; and a data area corresponding to the characteristic of the data. The data management method comprising the steps of: extracting the characteristic of the data from data to be stored in the data area; storing the data in the data area based on the extracted characteristic of the data; specifying a corresponding data area based on the characteristic of the data stored in the data area by referring to the correspondence information; and accessing, by each of the plurality of data servers, the specified data area.

Hereinafter, description will be made of means for achieving the object by referring to the drawings.

Distribution of data according to this invention is divided into a step (storage phase) of storing data and a step (management phase) of managing the data.

FIG. 27 is a diagram showing a concept of the storage phase for a parallel database system to which this invention is applied.

The parallel database system includes a data loading control server 2715, an original management server 2717, a storage medium 2719, a plurality of data servers, and a storage medium 2720.

The data loading control server 2715 controls distribution of original data to the plurality of data servers. The data loading control server 2715 includes a data loading control program 2716 for controlling the distribution of data.

The original management server 2717 manages data to be registered in the plurality of data servers. The original management server 2717 includes a data read program 2718 for reading registration subject data from the storage medium 2719.

The storage medium 2719 stores the data to be registered in the plurality of data servers. The storage medium 2720 includes a reference path controller 2721 for controlling data storage areas referenced by the plurality of data servers.

In FIG. 27, the plurality of data servers includes data servers 2701 to 2703. Hereinbelow, the data server will be described by taking the data server 2701 as an example. The other data servers including the data servers 2702 and 2703 each have the same configuration and can execute the same processing as the data server 2701.

The data server 2701 includes a data storage management program 2713, correspondence information between a characteristic of data and a data server that manages the characteristic of data, and a correspondence management list 2714.

The data storage management program 2713 has a function of extracting a data characteristic from registration subject data. The correspondence management list 2714 contains a correspondence relationship between a data server (storage server) that stores data in each data storage area in the storage phase and a data server (management server) that manages the data stored in the each data storage area in the management phase.

The storage medium 2720 shown in FIG. 27 includes data storage areas 2704 to 2712.

Hereinafter, description will be made of an outline of the processing effected in the storage phase.

A CPU (not shown) of the data loading control server 2715 executes the data loading control program 2716 to set all of the data servers in the correspondence management list 2714 as the management servers for all of the data storage areas. In addition, the storage servers and the management servers for all of the data storage areas are set in the correspondence management list 2714 so that all of the data servers are included in the storage servers for the data storage areas for which the same data server is set as the management server. The CPU of the data loading control server 2715 executes the data storage management program 2713 to instruct the reference path controller 2721 to allow each data server to reference the data storage areas for which the each data server is set as the storage server.

The data server 2701 represents the management server for the data storage areas 2704, 2707, and 2710. The storage servers for the data storage areas 2704, 2707, and 2710 are the data servers 2701, 2702, and 2703, respectively.

The data server 2702 represents the management server for the data storage areas 2705, 2708, and 2711. The storage servers for the data storage areas 2705, 2708, and 2711 are the data servers 2701, 2702, and 2703, respectively.

The data server 2703 represents the management server for the data storage areas 2706, 2709, and 2712. The storage servers for the data storage areas 2706, 2709, and 2712 are the data servers 2701, 2702, and 2703, respectively.

To describe an entire flow of the processing effected in the storage phase, first, a CPU (not shown) of the data server 2701 executes the data storage management program 2713 to control the data server 2701 to reference the data storage areas 2704 to 2706.

The CPU of the data loading control server 2715 executes the data loading control program 2716 to instruct the original management server 2717 to read data.

A CPU (not shown) of the original management server 2717 executes the data read program 2718 to acquire registration subject data, transmit the acquired data to the arbitrary data server 2701, and instruct data storage to each data server.

The CPU of the data server 2701 executes the data storage management program 2713 to extract a characteristic of the data transmitted from the original management server 2717, and references the correspondence management list 2714 to store the data in a data storage area corresponding to the characteristic of the data.

For example, the CPU of the data server 2701 stores the data, which has been transmitted to the data server 2701 and has the characteristic managed by the data server 2703, in the data storage area 2706, the storage server for which is the data server 2701 and the management server for which is the data server 2703.

After all of the registration subject data are stored in the data storage area, the parallel database system advances to the management phase.

FIG. 28 is a diagram showing a concept of the management phase for the parallel database system to which this invention is applied.

In the management phase, the CPU of the data loading control server 2715 executes the data loading control program 2716 to instruct each data server to allow the data storage areas for which the each data server is set as the management server to be referenced. Each data server executes the data storage management program 2713 to instruct the reference path controller 2721 to change the data storage areas referenced by the each data server.

According to the embodiment of this invention, it is possible to reduce a time necessary for distribution of data by analyzing the characteristic of data distributed to each data server and storing the data in the storage area of the data server based on the characteristic of the data.

### BRIEF DESCRIPTION OF THE DRAWINGS

The present invention can be appreciated by the description which follows in conjunction with the following figures, wherein:

FIG. 1 is a block diagram showing a configuration of a system including a parallel database in accordance with a first embodiment of this invention;

FIG. 2 is a diagram showing a procedure for a data loading processing in accordance with the first embodiment of this invention;

FIG. 3 is a diagram showing an example of a data loading subject data list inputted upon execution of the data loading processing in accordance with the first embodiment of this invention;

FIG. 4 is a diagram showing an example of a storage destination data server list inputted upon execution of the data loading processing in accordance with the first embodiment of this invention;

FIG. 5 is a diagram showing a procedure for a path creation processing in accordance with the first embodiment of this invention;

FIG. 6 is a diagram showing an example of a correspondence management list in accordance with the first embodiment of this invention;

FIG. 7 is a diagram showing an example of a path management information in accordance with the first embodiment of this invention;

FIG. 8 is a diagram showing a procedure for a data distribution processing in accordance with the first embodiment of this invention;

FIG. 9 is a PAD showing a procedure for an actual data acquisition processing in accordance with the first embodiment of this invention;

FIG. 10 is a diagram showing a procedure for a storage management processing in accordance with the first embodiment of this invention;

FIG. 11 is a diagram showing an XML document as an example of a distribution data entity in accordance with the first embodiment of this invention;

FIG. 12 is a diagram showing an example of analyzed data resulting from analysis of the distribution data entity in accordance with the first embodiment of this invention;

FIG. 13 is a diagram showing a procedure for a reference switch processing in accordance with the first embodiment of this invention;

FIG. 14 is a diagram showing a state (storage phase) before start of the reference switch processing in accordance with the first embodiment of this invention;

FIG. 15 is a diagram for explaining a state (management phase) after end of the reference switch processing in accordance with the first embodiment of this invention;

FIG. 16 is a diagram showing a procedure for a data loading processing in accordance with a second embodiment of this invention;

FIG. 17 is a diagram showing a procedure for a storage management processing in accordance with the second embodiment of this invention;

FIG. 18 is a block diagram showing a configuration of a system including a parallel database in accordance with a third embodiment of this invention;

FIG. 19 is a diagram showing a procedure for a data distribution/acquisition processing in accordance with the third embodiment of this invention;

FIG. 20 is a PAD showing a procedure for a data loading processing in accordance with a fourth embodiment of this invention;

FIG. 21 is a diagram showing a procedure for a path creation processing in accordance with the fourth embodiment of this invention;

FIG. 22 is a diagram showing a procedure for a storage management processing in accordance with the fourth embodiment of this invention;

FIG. 23 is a diagram showing a procedure for a reference switch processing in accordance with the fourth embodiment of this invention;

FIG. 24 is a block diagram showing a configuration of a system including a parallel database in accordance with a fifth embodiment of this invention;

FIG. 25 is a diagram showing a procedure for a data loading processing in accordance with the fifth embodiment of this invention;

FIG. 26 is a diagram showing a procedure for allocation change processing for computer resources in a virtualization server in accordance with the fifth embodiment of this invention;

FIG. 27 is a diagram showing a concept of the storage phase for a parallel database system in accordance with this invention; and

FIG. 28 is a diagram showing a concept of the management phase for the parallel database system in accordance with this invention.

### DETAILED DESCRIPTION OF THE PREFERRED EMBODIMENTS

Hereinafter, description will be made of an embodiment of this invention by referring to the drawings.

### First Embodiment

In a parallel database system according to a first embodiment of this invention, an area accessed by each data server is switched between areas accessed in a storage phase, which is a step of storing data stored in a database, and a management phase, which is a step of managing the data. Even if data distributed to a data server has a different characteristic from a characteristic of data to be managed by the data server, each data server can manage data having a characteristic to be managed by the each data server in the management phase. Hereinbelow, description will be made of the parallel database system according to the first embodiment of this invention.

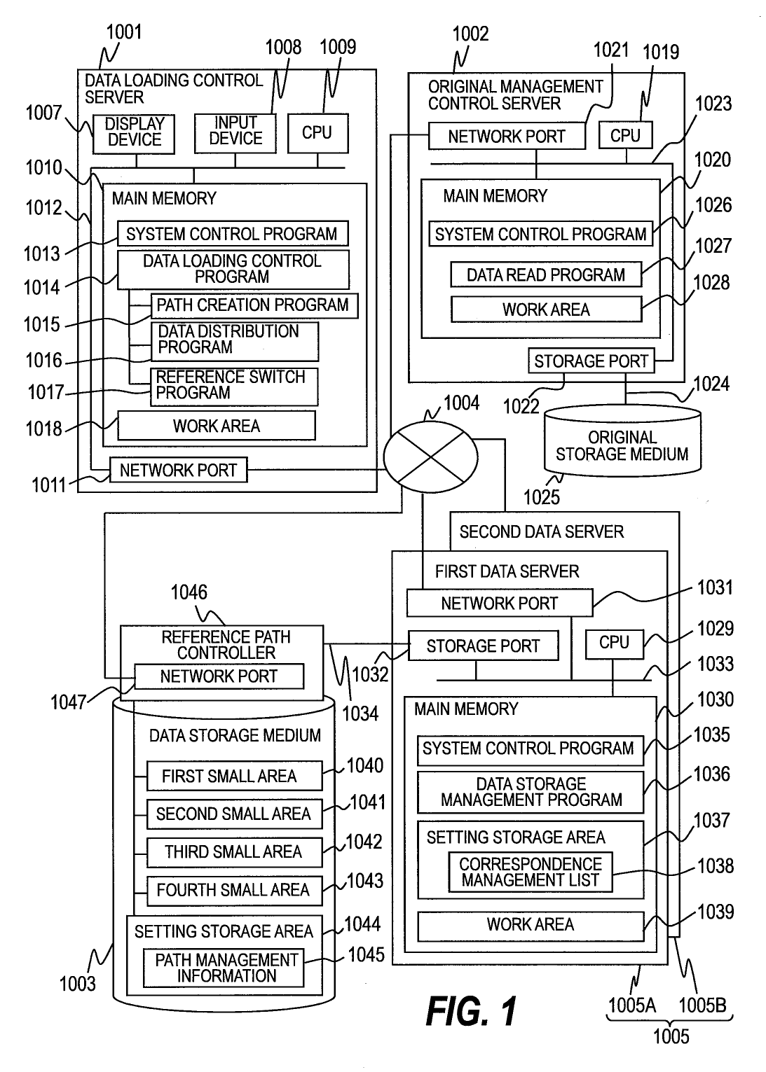

FIG. 1 is a diagram showing a configuration of a system including a parallel database according to the first embodiment of this invention.

The system includes a data loading control server 1001, an original management control server 1002, a data storage medium 1003, and a data server 1005. In the first embodiment of this invention, the data server 1005 includes a first data server 1005A and a second data server 1005B. The first embodiment of this invention includes two data servers, but may be changed depending on the system configuration.

The data loading control server 1001 includes a CPU 1009, a main memory 1010, a network port 1011, a display device 1007, and an input device 1008. The CPU 1009, the main memory 1010, the network port 1011, the display device 1007, and the input device 1008 are coupled to one another through a bus 1012.

The CPU 1009 executes a program stored in the main memory 1010, and executes a predetermined processing. The main memory 1010 stores the program executed by the CPU 1009, and data necessary for execution of the program.

The main memory 1010 stores a system control program 1013 and a data loading control program 1014. The main memory 1010 also includes a work area 1018. The system control program 1013 and the data loading control program 1014, which are recorded in a recording medium such as a magnetic disk, a flash memory or a CD-ROM, are loaded into the main memory 1010 before execution thereof.

The system control program 1013 is executed by the CPU 1019 to execute a predetermined processing based on a control signal received from an external component or a state of the data loading control server 1001.

The data loading control program 1014 is executed by the CPU 1009 to cause data dispersed across a plurality of data servers to function as a single parallel database. The data loading control program 1014 includes a path creation program 1015, a data distribution program 1016, and a reference switch program 1017.

The path creation program 1015 is executed by the CPU 1009 to set: information on paths (communication channels) for coupling small areas that corresponds to the number of data servers and are stored in the data storage medium 1003 and the data servers; and correspondence relationships between the data servers and the small areas at times of distribution and management.

The data distribution program 1016 is executed by the CPU 1009 to select a distribution destination data server 8101 to which distribution subject data 5101 is distributed.

The reference switch program 1017 is executed by the CPU 1009 to switch permissions to reference paths between the data servers and the small areas based on information on paths between the data servers and the small areas, from the permissions for one of the storage phase and the management phase to the permissions for the other.

Stored in the work area 1018 is data that is temporarily necessary to execute each program.

The network port 1011 exchanges data and a signal with another server via the network 1004. The display device 1007 displays results of various processings and the like. The input device 1008 allows inputs of a command of an executed processing, information necessary therefor, and the like.

The original management control server 1002 includes a CPU 1019, a main memory 1020, a network port 1021, and a storage port 1022. The CPU 1019, the main memory 1020, the network port 1021, and the storage port 1022 are coupled to one another through a bus 1023.

The CPU 1019 executes a program stored in the main memory 1020, and executes a predetermined processing. The main memory 1020 stores the program executed by the CPU 1019, and data necessary for execution of the program.

The main memory 1020 stores a system control program 1026 and a data read program 1027. The main memory 1020 also includes a work area 1028.

The system control program 1026 is executed by the CPU 1019 to execute a predetermined processing based on a control signal received from an external component or a state of the original management control server 1002.

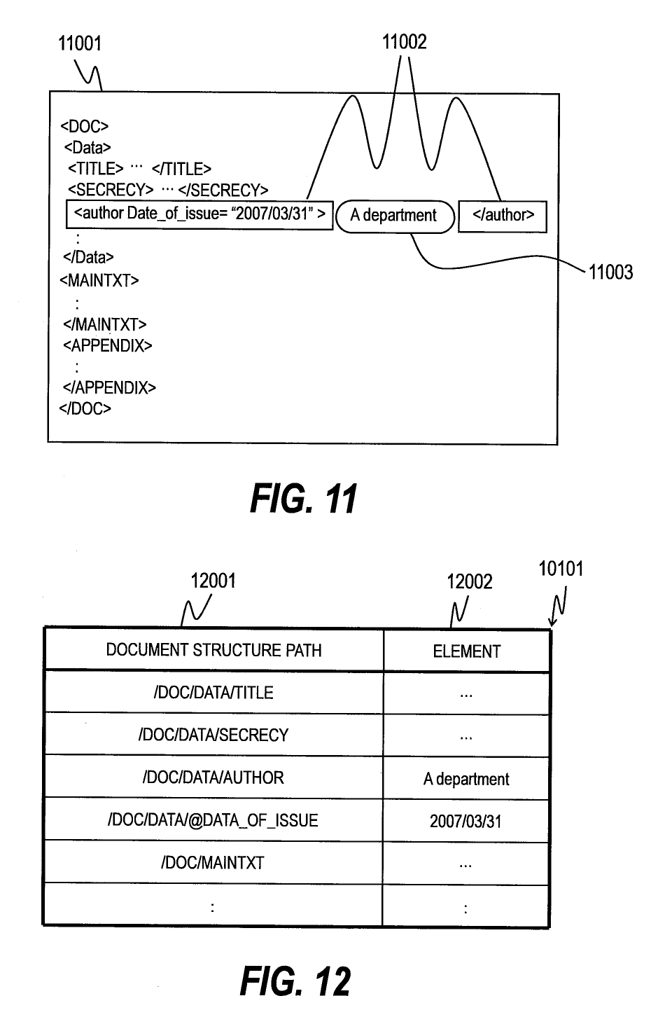

The data read program 1027 represents a processing section that is executed by the CPU 1019 to acquire the distribution subject data 5101 stored in an original storage medium 1025, and transmit a distribution data entity 9101 to the distribution destination data server 8101. Examples of the distribution data entity 9101 include an XML document. An example of the XML document will be described later by referring to FIG. 11.

Temporarily stored in the work area 1028 is data that is necessary to execute each program.

The network port 1021 exchanges data and a signal with another server via the network 1004. The storage port 1022 is coupled to a fibre channel 1024 serving as a communication channel to the original storage medium 1025.

The original storage medium 1025 represents a storage medium for actually storing the distribution data entity 9101. The original storage medium 1025 is coupled to the original management control server 1002 via the fibre channel 1024.

The data server 1005 includes a CPU 1029, a main memory 1030, a network port 1031, and a storage port 1032. The CPU 1029, the main memory 1030, the network port 1031, and the storage port 1032 are coupled to one another through a bus 1033. The data server 1005 generically represents a plurality of data servers included in the parallel database system. The first embodiment of this invention includes two data servers 1005, in other words, the first data server 1005A and the second data server 1005B. It should be noted that the first data server 1005A and the second data server 1005B have the same configuration.

The data server 1005 is coupled to the data storage medium 1003 serving as a data storage destination by a fibre channel 1034 serving as a communication channel between the storage port 1032 and the data storage medium 1003.

The main memory 1030 stores a system control program 1035 and a data storage management program 1036. The main memory 1030 includes a setting storage area 1037 and a work area 1039. The programs stored in the main memory 1030 are executed by the CPU 1029 to execute predetermined processings.

The system control program 1035 is executed by the CPU 1029 to execute a predetermined processing based on a control signal received from an external component or a state of the data server 1005.

The data storage management program 1036 is executed by the CPU 1029 to analyze the distribution data entity 9101, and decide which data server 1005 is to manage the data based on the analysis results and the correspondence relationships between data servers and small areas. The data storage management program 1036 stores the data in the small area managed by the decided data server in the management phase.

Stored in the setting storage area 1037 is a correspondence management list 1038. The correspondence management list 1038 stores correspondence relationships between the data servers 1005 and the small areas secured in the data storage medium 1003. It should be noted that the setting storage area 1037 is secured in the main memory 1030 in the first embodiment of this invention, but may be secured on a magnetic disk or in other such storage medium.

The data storage medium 1003 includes at least one small area and a setting storage area 1044. In the first embodiment of this invention, the at least one small area includes a first small area 1040, a second small area 1041, a third small area 1042, and a fourth small area 1043. The data storage medium 1003 is coupled with a reference path controller 1046 for controlling a permission to reference a path between the data server 1005 and the small area. Stored in the setting storage area 1044 is path management information 1045.

The reference path controller 1046 includes a network port 1047 for exchanging data and a signal with another server via the network 1004.

Next, description will be made of the processing according to the first embodiment of this invention.

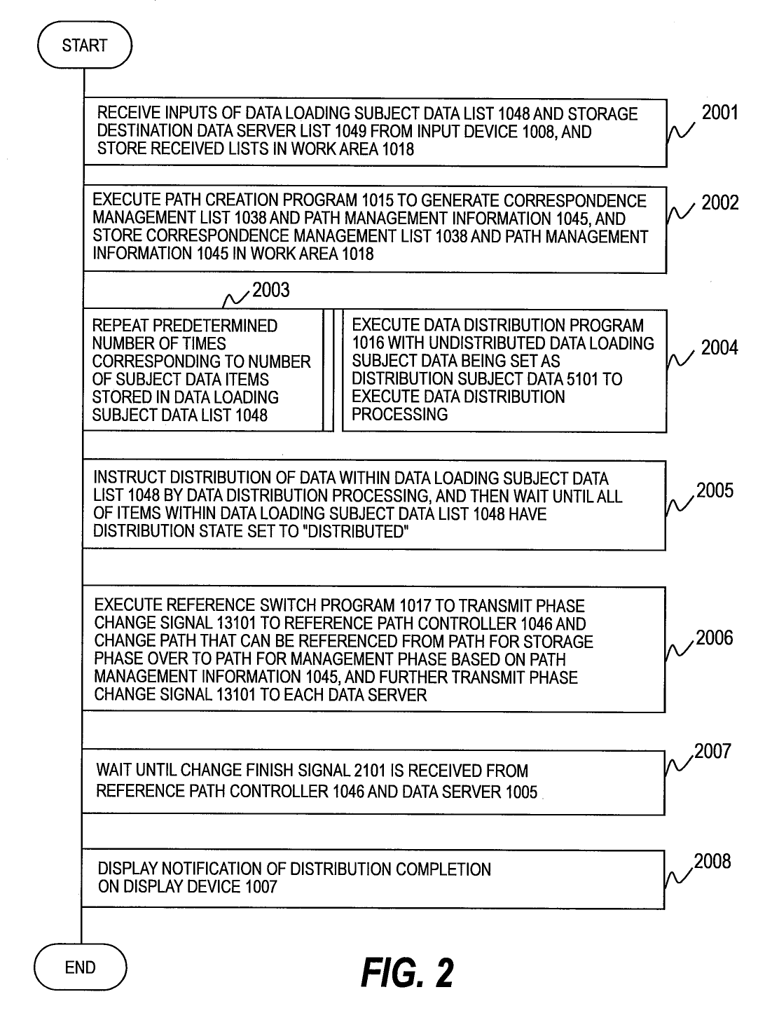

FIG. 2 is a diagram showing a procedure for a data loading processing according to the first embodiment of this invention. The flow of the processing shown in FIG. 2 is expressed by problem analysis diagram (PAD).

The CPU 1009 of the data loading control server 1001 processes the data loading control program 1014 to execute the data loading processing.

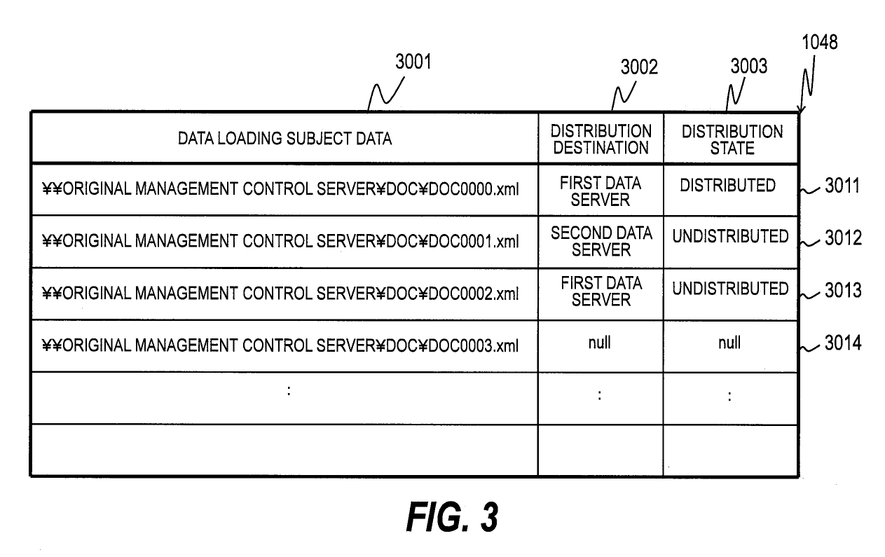

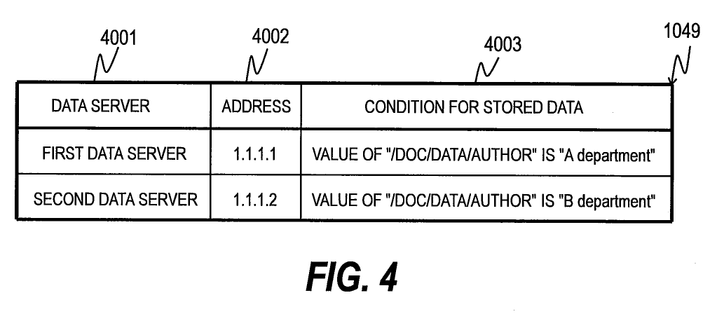

The CPU 1009 receives inputs of the data loading subject data list 1048 and the storage destination data server list 1049 from the input device 1008 (Step 2001). The inputted data loading subject data list 1048 and storage destination data server list 1049 are stored in the work area 1018. The data loading subject data list 1048 and the storage destination data server list 1049 will be described later in detail by referring to FIG. 3 and FIG. 4, respectively.

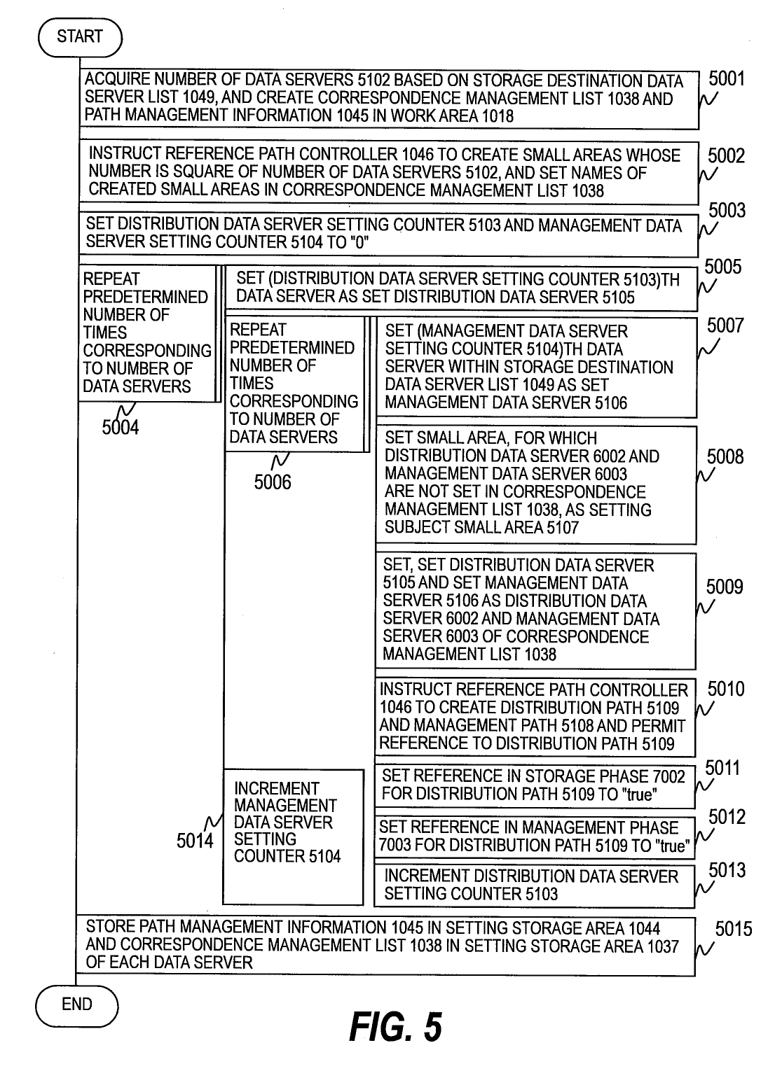

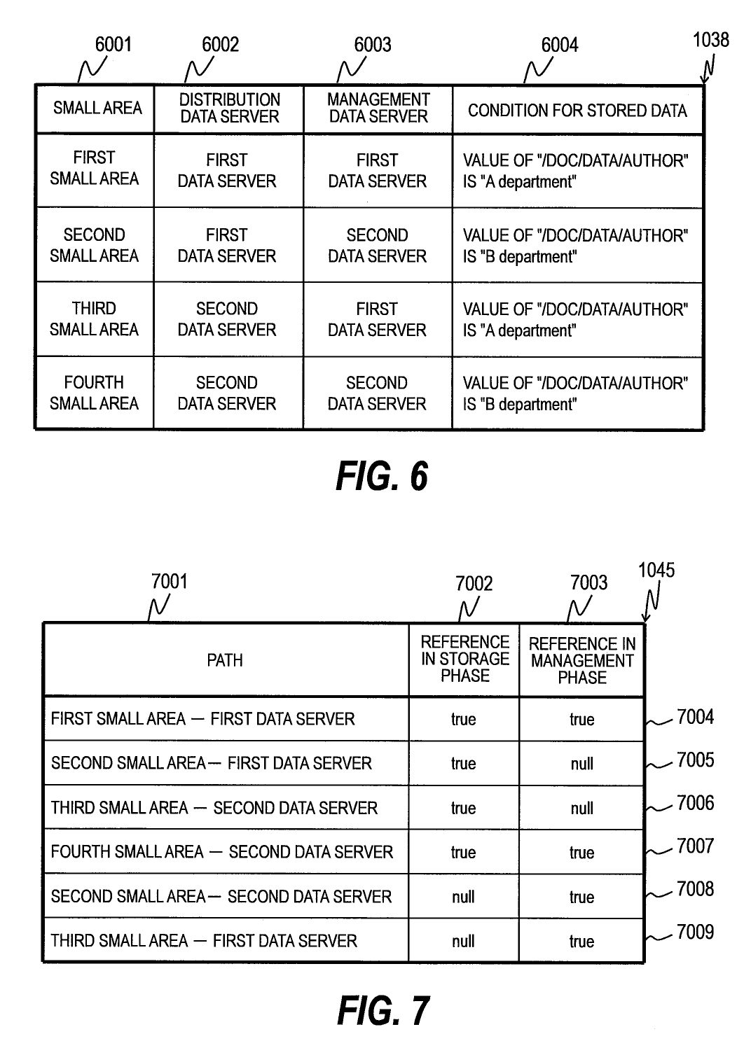

The CPU 1009 activates the path creation program 1015 to perform a path creation processing of generating the correspondence management list 1038 and the path management information 1045 (Step 2002). The generated correspondence management list 1038 and path management information 1045 are stored in the work area 1018. The procedure for the path creation processing will be described later by referring to FIG. 5. The generated correspondence management list 1038 and path management information 1045 will be described later in detail by referring to FIG. 6 and FIG. 7, respectively.

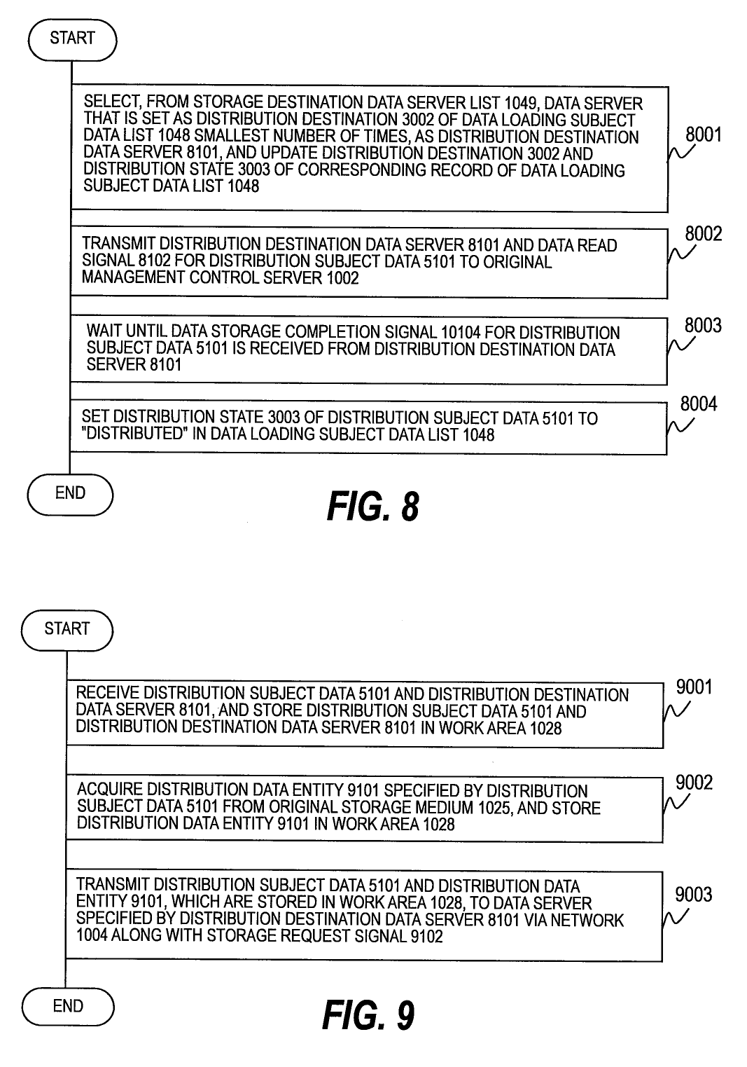

The CPU 1009 repeats a data distribution processing a predetermined number of times corresponding to the number of data loading subject data items 3001 stored in the data loading subject data list 1048 (Step 2003). The data distribution processing is executed by executing the data distribution program 1016 with one of undistributed data loading subject data items being set as the distribution subject data 5101 (Step 2004). The procedure for the data distribution processing will be described later by referring to FIG. 8.

The CPU 1009 processes the data distribution program 1016 to instruct distribution of data listed in the data loading subject data list 1048, and then waits until all of the items within the data loading subject data list 1048 have the distribution state 3003 set to “distributed” (Step 2005).

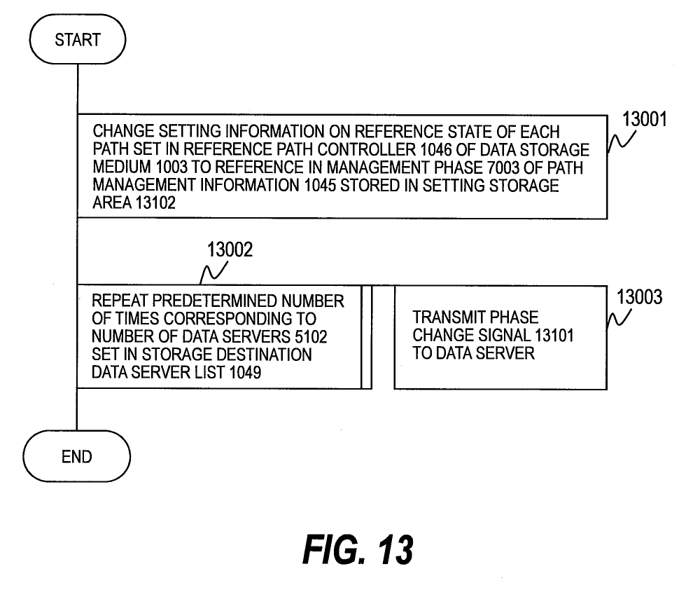

After all of the distribution states 3003 in the data loading subject data list 1048 are set to “distributed”, the CPU 1009 processes the reference switch program 1017 to execute a reference switch processing (Step 2006). In the reference switch processing, the CPU 1009 transmits a phase change signal 13101 to the reference path controller 1046 of the data storage medium 1003, and changes a path that can be referenced from a path for the storage phase over to a path for the management phase based on the path management information 1045. Further, the CPU 1009 transmits the phase change signal 13101 to the data server 1005. The procedure for the reference switch processing will be described later by referring to FIG. 13.

The CPU 1009 waits until a change finish signal 2101 is received from the reference path controller 1046 of the data storage medium 1003 and from each data server (Step 2007).

Upon reception of the change finish signal 2101 from every data server, the CPU 1009 displays a notification of distribution completion on the display device 1007 (Step 2008). After Step 2008, the data loading processing comes to an end.

FIG. 3 is a diagram showing an example of the data loading subject data list 1048 inputted upon execution of the data loading processing according to the first embodiment of this invention. The data loading subject data list 1048 is held in the work area 1018 of the data loading control server 1001 from the start of the data loading processing until the end thereof.

The data loading subject data list 1048 contains a data loading subject data item 3001, a distribution destination 3002, and a distribution state 3003.

The data loading subject data item 3001 indicates a location where an entity of the distribution subject data 5101 (distribution data entity 9101) is stored. The data loading subject data item 3001 is inputted from the input device 1008 in the Step 2001 of FIG. 2.

The distribution destination 3002 represents an identifier indicating a data server to which the distribution subject data 5101 is to be transmitted. The distribution destination 3002 has “null” set as an initial value, and the distribution destination data server 1005 is set as the distribution destination 3002 based on the results of analyzing the distribution subject data 5101 in the data distribution processing.

The distribution state 3003 represents a state of the distribution subject data 5101 in the course of the data distribution processing. To be specific, when the distribution destination 3002 is the initial value “null”, if the data distribution program 1016 is executed to set the distribution destination 3002, the distribution state 3003 is set to a value “undistributed”. If the data storage management program 1036 is executed to store the distribution subject data 5101 in the small area, the distribution state 3003 is set to “distributed”.

Referring to FIG. 3, the data loading subject data list 1048 contains records 3011 to 3014.

The record 3011 has “¥¥original management control server¥DOC¥DOC0000.xml” set as the data loading subject data item 3001 and “first data server” as the distribution destination 3002, and indicates a state where the data loading subject data item 3001 has already been stored in the small area.

The record 3012 has “¥¥original management control server¥DOC¥DOC0001.xml” set as the data loading subject data item 3001 and “second data server” as the distribution destination 3002, and indicates a state where the data loading subject data item 3001 is not currently stored in the small area. The record 3013 has “¥¥original management control server¥DOC¥DOC0002.xml” set as the data loading subject data item 3001 and “first data server” as the distribution destination 3002, and also indicates the state where the data loading subject data item 3001 is not currently stored in the small area.

The record 3014 has “¥¥original management control server¥DOC¥DOC0003.xml” set as the data loading subject data item 3001, “null” set for the distribution destination 3002, and “null” set for the distribution state 3003.

FIG. 4 is a diagram showing an example of the storage destination data server list 1049 inputted upon execution of the data loading processing according to the first embodiment of this invention. The storage destination data server list 1049 is held in the work area 1018 of the data loading control server 1001 from when the input is received from the input device 1008 in Step 2001 of FIG. 2 until the data loading processing comes to an end.

The storage destination data server list 1049 contains a data server 4001, an address 4002, and a condition for stored data 4003.

The data server 4001 represents a name of the data server 1005. The address 4002 represents information for identifying the location of the data server within the network 1004. Examples of the address 4002 include an IP address. The condition for stored data 4003 represents a condition for storing data to be managed by the data server.

Referring to FIG. 4, the storage destination data server list 1049 contains information on the first data server 1005A and the second data server 1005B.

The first data server 1005A exists at the address “1.1.1.1”, to which data whose “value of “/DOC/DATA/AUTHOR” is “A department”” is distributed. The second data server 1005B exists at the address “1.1.1.2”, to which data whose “value of “/DOC/DATA/AUTHOR” is “B department”” is distributed.

Next, description will be made of the path creation processing. The path creation processing is executed by the CPU 1009 processing the path creation program 1015 in Step 2002 of FIG. 2.

FIG. 5 is a PAD showing a procedure for the path creation processing according to the first embodiment of this invention.

The CPU 1009 first references the storage destination data server list 1049 stored in the work area 1018 to acquire the number of data servers 5102. The CPU 1009 then creates in the work area 1018 the path management information 1045 and the correspondence management list 1038 in a state where data is not stored (Step 5001). The correspondence management list 1038 and the path management information 1045 will be described later in detail by referring to FIG. 6 and FIG. 7, respectively.

The CPU 1009 instructs the reference path controller 1046 of the data storage medium 1003 to create small areas whose number is the square of the number of data servers 5102. The CPU 1009 also sets names of the created small areas in the correspondence management list 1038 (Step 5002).

The CPU 1009 sets a distribution data server setting counter 5103 and a management data server setting counter 5104 to “0” (Step 5003). The distribution data server setting counter 5103 and the management data server setting counter 5104 represent variables stored temporarily in the main memory 1010.

The CPU 1009 executes a distribution data server deciding loop processing (Steps 5005 to 5014) a predetermined number of times corresponding to the number of data servers 5102 (Step 5004).

In the distribution data server deciding loop processing, the CPU 1009 first sets the (distribution data server setting counter 5103)th data server of the storage destination data server list 1049 as a set distribution data server 5105 (Step 5005).

The CPU 1009 then executes a storage data server deciding loop processing (Steps 5007 to 5013) the predetermined number of times corresponding to the number of data servers 5102 (Step 5006).

In the storage data server deciding loop processing, the CPU 1009 first sets the (management data server setting counter 5104)th data server of the storage destination data server list 1049 as a set management data server 5106 (Step 5007).

The CPU 1009 then sets a small area, for which a distribution data server 6002 and a management data server 6003 are not set in the correspondence management list 1038, as a setting subject small area 5107 (Step 5008).

The CPU 1009 updates a record corresponding to the setting subject small area 5107 in the correspondence management list 1038. To be specific, the CPU 1009 sets the set distribution data server 5105 as the distribution data server 6002 and the set management data server 5106 as the management data server 6003. The CPU 1009 then references the storage destination data server list 1049 to acquire the condition for stored data 4003 corresponding to the set management data server 5106, and sets the condition as a condition for stored data 6004 (Step 5009).

The CPU 1009 instructs the reference path controller 1046 of the data storage medium 1003 to create a distribution path 5109 and a management path 5108 and permit a reference to the distribution path 5109 (Step 5010). The distribution path 5109 represents a path obtained by coupling the setting subject small area 5107 and the distribution data server 6002. The management path 5108 represents a path obtained by coupling the setting subject small area 5107 and the management data server 6003.

The CPU 1009 sets a reference in a storage phase 7002 for the distribution path 5109 in the path management information 1045 to “true” (permitted state), thereby permitting the reference to the corresponding path (Step 5011).

The CPU 1009 sets a reference in a management phase 7003 for the management path 5108 in the path management information 1045 to “true” (permitted state) (Step 5012). The CPU 1009 then increments the distribution data server setting counter 5103 (Step 5013), and ends the storage data server deciding loop processing.

The CPU 1009 further increments the management data server setting counter 5104 (Step 5014), and ends the distribution data server deciding loop processing.

The CPU 1009 stores the path management information 1045 in the setting storage area 1044 of the data storage medium 1003. The CPU 1009 further stores the correspondence management list 1038 in the setting storage area 1037 of each data server (Step 5015). After the end of the above-mentioned processings, the path creation processing comes to an end.

FIG. 6 is a diagram showing an example of the correspondence management list 1038 according to the first embodiment of this invention. FIG. 6 indicates the correspondence management list 1038 at the time when the path creation processing comes to an end. The correspondence management list 1038 holds a server that accesses a small area storing given data and a condition for the stored data.

The correspondence management list 1038 contains a small area 6001, the distribution data server 6002, the management data server 6003, and the condition for stored data 6004.

The small area 6001 represents a name of the small area created for each data server. The small area 6001 is set in Step 5002 of FIG. 5.

The distribution data server 6002 represents a name of the data server that actually stores data in the small area 6001. The distribution data server 6002 is set in Step 5009 of FIG. 5.

The management data server 6003 represents a name of the data server that manages the data stored in the small area 6001. The management data server 6003 is set in Step 5009 of FIG. 5.

The condition for stored data 6004 represents a condition for the data stored in the small area 6001. Base on the information of the storage destination data server list 1049, the condition for stored data 4003 corresponding to the data server specified by the distribution data server 6002 is set as the condition for stored data 6004.

When the name of a new small area is set as the small area 6001, the distribution data server 6002, the management data server 6003, and the condition for stored data 6004 are set to the initial value “null”.

According to the correspondence management list 1038 shown in FIG. 6, in the storage phase, data whose “value of “/DOC/DATA/AUTHOR” is “A department”” is stored in the first small area 1040 by the first data server 1005A. Similarly, data whose “value of “/DOC/DATA/AUTHOR” is “B department”” is stored in the second small area 1041 by the first data server 1005A. On the other hand, data whose “value of “/DOC/DATA/AUTHOR” is “A department”” is stored in the third small area 1042 by the second data server 1005B. Similarly, data whose “value of “/DOC/DATA/AUTHOR” is “B department”” is stored in the fourth small area 1043 by the second data server 1005B.

In the management phase, the first small area 1040 and the third small area 1042 in which the data whose “value of “/DOC/DATA/AUTHOR” is “A department”” is stored are managed by the first data server 1005A. Similarly, the second small area 1041 and the fourth small area 1043 in which the data whose “value of “/DOC/DATA/AUTHOR” is “B department”” is stored are managed by the second data server 1005B.

FIG. 7 is a diagram showing an example of the path management information 1045 according to the first embodiment of this invention. FIG. 7 indicates the path management information 1045 at the time when the path creation processing comes to an end. The path management information 1045 holds a coupling relationship between the small area and the data server.

A path 7001 represents a path defined by a small area paired with a data server that is coupled to the small area through the path. The path 7001 is set in Step 5011 or 5012 of FIG. 5. For example, “first small area—first data server” means a path coupling the first small area and the first data server.

The reference in a storage phase 7002 indicates whether or not the reference to the path is permitted in the storage phase. The reference in a storage phase 7002 is set in Step 5011 of FIG. 5. The reference in a management phase 7003 indicates whether or not the reference to the path is permitted in the management phase. The reference in a management phase 7003 is set in Step 5012 of FIG. 5.

The initial values of the reference in a storage phase 7002 and the reference in a management phase 7003 are “null”. If the reference in a storage phase 7002 and the reference in a management phase 7003 are set to the initial value “null”, the use of the path is not permitted, and if set to a value “true”, the use of the path is permitted.

According to the path management information 1045 shown in FIG. 7, in the storage phase, paths corresponding to records 7004 to 7007 can be used. To be specific, the four paths represented by “first small area—first data server”, “second small area—first data server”, “third small area—second data server”, and “fourth small area—second data server” can be used.

In the management phase, paths corresponding to records 7004 and 7007 to 7009 can be used. To be specific, the four paths represented by “first small area—first data server”, “second small area—second data server”, “third small area—first data server”, and “fourth small area—second data server” can be used.

Next, description will be made of the data distribution processing. The data distribution processing is executed by the CPU 1009 processing the data distribution program 1016 in Step 2004 of FIG. 2.

FIG. 8 is a PAD showing a procedure for the data distribution processing according to the first embodiment of this invention.

The CPU 1009 of the data loading control server 1001 first selects, from the storage destination data server list 1049, one data server that is set as the distribution destination 3002 of the data loading subject data list 1048 the smallest number of times, as the distribution destination data server 8101. The CPU 1009 then sets the selected distribution destination data server 8101 in the data loading subject data list 1048 as the distribution destination 3002 for the distribution subject data 5101 (Step 8001). By thus allocating data preferentially to the data server that is set as the distribution destination 3002 the smallest number of times, data can be distributed evenly to the respective data servers. The CPU 1009 further sets the distribution state 3003 of the data loading subject data list 1048 to the value “undistributed”.

The CPU 1009 transmits identifier of the selected distribution destination data server 8101 and a data read signal 8102 for the distribution subject data 5101 to the original management control server 1002 that stores the distribution subject data 5101 (Step 8002).

The CPU 1009 then waits until a data storage completion signal 10104 for the distribution subject data 5101 is received from the distribution destination data server 8101 (Step 8003).

The CPU 1009 sets the distribution state 3003 of the distribution subject data 5101 to “distributed” in the data loading subject data list 1048 (Step 8004). After Step 8004 is complete, the data distribution processing comes to an end.

Next, description will be made of an actual data acquisition processing. The actual data acquisition processing is executed by the data read program 1027 processed when the original management control server 1002 receives the data read signal 8102 transmitted from the data loading control server 1001 in Step 8002 of FIG. 8.

FIG. 9 is a PAD showing a procedure for the actual data acquisition processing according to the first embodiment of this invention.

The CPU 1019 of the original management control server 1002 receives the distribution subject data 5101 and the distribution destination data server 8101, and stores the distribution subject data 5101 and the distribution destination data server 8101 in the work area 1028 (Step 9001).

The CPU 1019 acquires the distribution data entity 9101 (for example, an XML document) specified by the distribution subject data 5101 from the original storage medium 1025, and stores the distribution data entity 9101 in the work area 1028 (Step 9002).

The CPU 1019 transmits the distribution subject data 5101 and the distribution data entity 9101, which are stored in the work area 1028, to a data server specified by the distribution destination data server 8101 via the network 1004 along with a storage request signal 9102 (Step 9003). After the end of Step 9003, the actual data acquisition processing comes to an end.

Next, description will be made of a storage management processing. The storage management processing is executed by the data storage management program 1036 processed when the data server 1005 receives the storage request signal 9102 transmitted from the original management control server 1002 in Step 9003 of FIG. 9. The storage management processing is also executed by the data storage management program 1036 processed when the data server 1005 receives the phase change signal 13101 transmitted from the data loading control server 1001 in Step 2006 of FIG. 2.

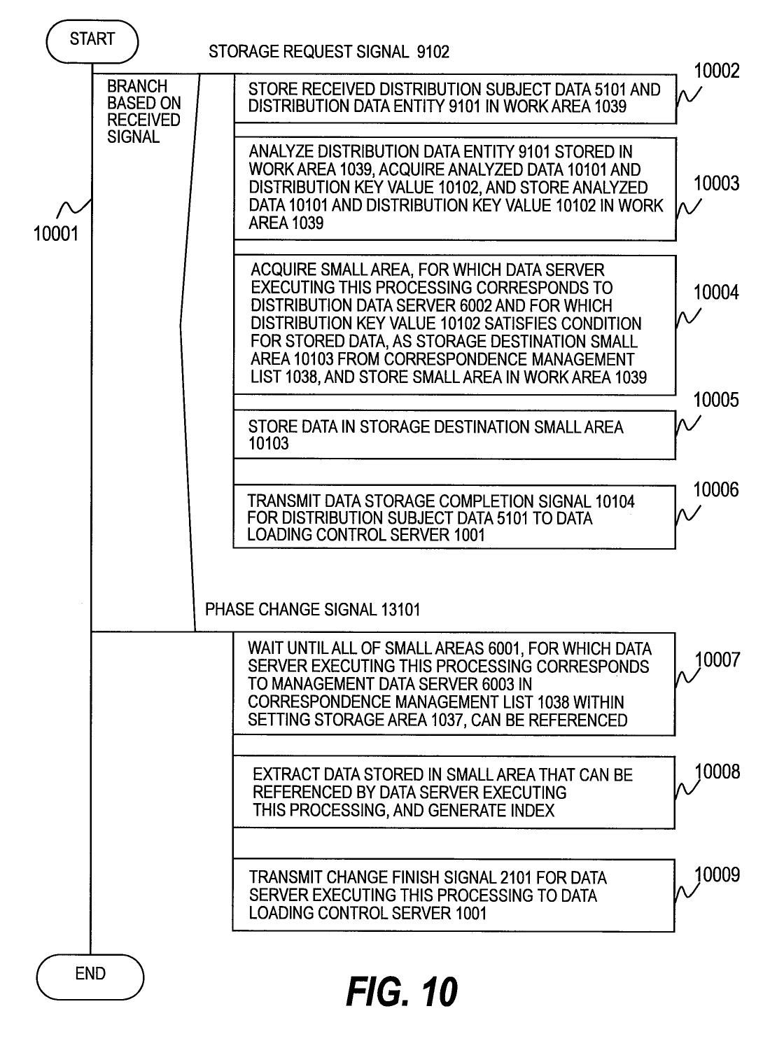

FIG. 10 is a PAD showing a procedure for the storage management processing according to the first embodiment of this invention.

The CPU 1029 of the data server 1005 branches the processing based on the received signal (Step 10001). To be specific, if the received signal is the storage request signal 9102, a data storage processing is executed. If the received signal is the phase change signal 13101, a phase change processing is executed.

First, description will be made of the data storage processing. The data storage processing is performed in Steps 10002 to 10006.

In the data storage processing, the CPU 1029 first stores the received distribution subject data 5101 and the distribution data entity 9101 in the work area 1039 (Step 10002).

The CPU 1029 analyzes the distribution data entity 9101 stored in the work area 1039, acquires analyzed data 10101 and a distribution key value 10102, and stores the analyzed data 10101 and the distribution key value 10102 in the work area 1039 (Step 10003). The analyzed data 10101 will be described later in detail by referring to FIG. 12.

Based on the analyzed data 10101, the CPU 1029 acquires a small area, for which the data server 1005 executing this processing corresponds to the distribution data server 6002 and for which the acquired distribution key value 10102 satisfies the condition for stored data 6004, as a storage destination small area 10103 from the correspondence management list 1038 stored in the setting storage area 1037, and stores the small area in the work area 1039 (Step 10004).

The CPU 1029 stores the distribution data entity 9101 in the storage destination small area 10103 of the data storage medium 1003 (Step 10005).

The CPU 1029 transmits the data storage completion signal 10104 for the distribution subject data 5101 to the data loading control server 1001 (Step 10006). After the end of Step 1006, the data storage processing comes to an end.

Next, description will be made of the phase change processing. The phase change processing is performed in Steps 10007 to 10009.

The CPU 1029 first waits until all of the small areas 6001, for which the data server executing this processing corresponds to the management data server 6003 in the correspondence management list 1038 within the setting storage area 1037, can be referenced (Step 10007).

The CPU 1029 extracts data stored in the small area that can be referenced by the data server executing this processing, and generates an index (Step 10008).

The CPU 1029 transmits the change finish signal 2101 for the data server executing this processing to the data loading control server 1001 (Step 10009). After the end of Step 10009, the phase change processing comes to an end.

Herein, the distribution data entity 9101 will be described in detail. According to the first embodiment of this invention, the distribution data entity 9101 represents an XML document.

FIG. 11 is a diagram showing an XML document 11001 as an example of the distribution data entity 9101 according to the first embodiment of this invention.

First, description will be briefly made of an XML document. In the XML for describing an XML document, an element is clearly located by a so-called tag which contains a character string that describes an attribute. In FIG. 11, “<AUTHOR>” and “</AUTHOR>” denoted by reference numeral 11002 represent tags.

The tags include a start tag (the “<AUTHOR>” part of the tags 11002) and an end tag (the “</AUTHOR>” part of the tags 11002). The start tag is the counterpart of the end tag. The tag is expressed by surrounding an element name by symbols. For example, the start tag “<AUTHOR>” is the counterpart of the “</AUTHOR>”, and the element name thereof is “AUTHOR”.

In addition, the XML document is allowed to have a hierarchical structure by using tags. The XML document holds data called an element between the start tag and the end tag. The description “<AUTHOR>A department</AUTHOR>” clarifies the element “A department”. Such a description method allows the XML document to describe both data and the meaning of the data by itself. In FIG. 11, an element 11003 “A department” is described as the element specified by the tags 11002. According to the first embodiment of this invention, the element is acquired as the distribution key value 10102. Further in the XML, an attribute can be added to the tag. The attribute is described by a set of an attribute name and a value. Referring to FIG. 11, the description “<AUTHOR DATE_OF_ISSUE=“2007/03/31”>A department</AUTHOR>” has the attribute name “DATE_OF_ISSUE” with the value “2007/03/31”.

It should be noted that the XML document is regarded as having a correct format as long as the start tag and the end tag form a pair and are located in the same tier, making it impossible to predict a location where each tag is described within the XML document. In other words, in an attempt to acquire the element specified by the element name “AUTHOR” from the XML document, the location where each tag appears is unknown until the XML document has been analyzed, so the element “A department” specified by the element name “AUTHOR” cannot be extracted. An analysis processing for the XML document is performed in Step 10003 of FIG. 10.

With reference to the correspondence management list 1038 of FIG. 6, in comparison with the condition for stored data 6004, the XML document 11001 is stored in the first small area if distributed to the first data server, or stored in the third small area if distributed to the second data server. In either case of being stored in the first small area or the third small area, the XML document 11001 is managed by the first data server in the management phase.

Next, the analyzed data 10101 will be described in detail.

FIG. 12 is a diagram showing an example of the analyzed data 10101 resulting from the analysis of the distribution data entity 9101 according to the first embodiment of this invention. The analyzed data 10101 shown in FIG. 12 is the result obtained by analyzing the XML document 11001 shown in FIG. 11 in Step 10003 of FIG. 10.

The analyzed data 10101 contains a document structure path 12001 and an element 12002. The document structure path 12001 represents a path for expressing the location of an element of a document structure obtained by analyzing the distribution data entity 9101. The element 12002 represents an entity of an element acquired from the distribution data entity 9101 by use of the corresponding document structure path 12001.

By thus using the analyzed data 10101, it is possible to acquire the element 12002 from the document structure path 12001.

Next, description will be made of the reference switch processing. The reference switch processing is executed by the CPU 1009 processing the reference switch program 1017 in Step 2006 of FIG. 2.

FIG. 13 is a PAD showing a procedure for the reference switch processing according to the first embodiment of this invention.

The CPU 1009 of the data loading control server 1001 changes a setting related to a reference state of each path set in the reference path controller 1046 of the data storage medium 1003 to a reference in a management phase 7003 of the path management information 1045 stored in a setting storage area 13102 (Step 13001).

The CPU 1009 repeatedly executes a change signal transmission processing a predetermined number of times corresponding to the number of data servers 5102 set in the storage destination data server list 1049 (Step 13002).

In the change signal transmission processing, the CPU 1009 transmits the phase change signal 13101 to the data server 1005 to which the phase change signal 13101 has not been transmitted (Step 13003). After the end of Step 13003, the change signal transmission processing comes to an end. After all of the data servers 1005 have been subjected to the change signal transmission processing, the reference switch processing comes to an end.

Herein, relationships between each data server and each small area before the start of the reference switch processing and after the end thereof will be described with reference to specific examples.

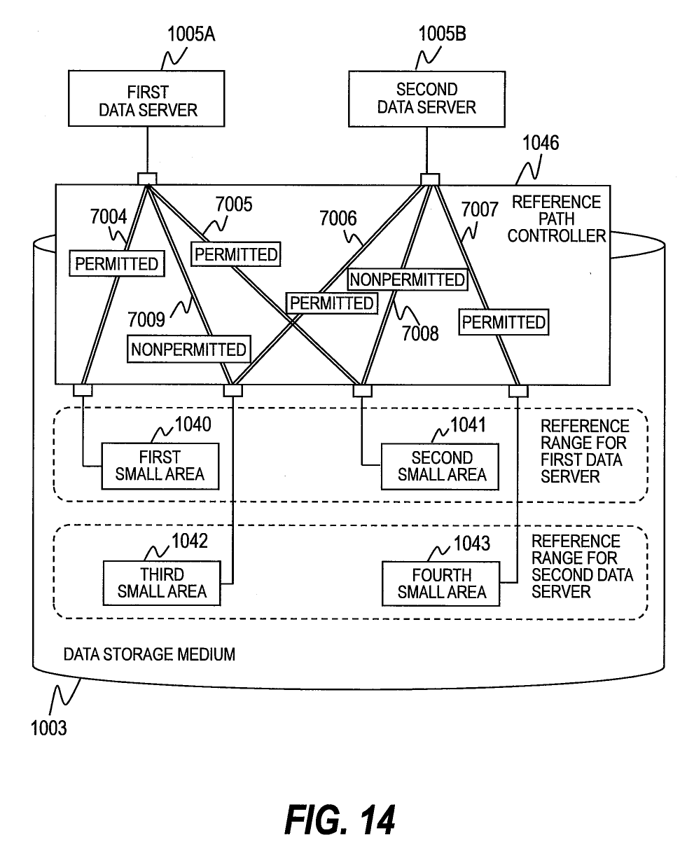

FIG. 14 is a diagram for explaining a state (storage phase) before the start of the reference switch processing according to the first embodiment of this invention.

Each data server (the first data server 1005A, the second data server 1005B) is coupled to each small area (the first small area 1040, the second small area 1041, the third small area 1042, the fourth small area 1043) via the reference path controller 1046.

By the path creation processing, the reference path controller 1046 generates six paths “first small area—first data server”, “second small area—first data server”, “third small area—second data server”, “fourth small area—second data server”, “second small area—second data server”, and “third small area—first data server”. The created six paths correspond to the records 7004 to 7009 of the correspondence management list 1038.

In the storage phase before the start of the reference switch processing, the first data server 1005A is permitted to use the paths “first small area—first data server” and “second small area—first data server” included in the records 7004 and 7005, respectively. Further, the data whose “value of “/DOC/DATA/AUTHOR” is “A department”” is stored in the first small area 1040, while the data whose “value of “/DOC/DATA/AUTHOR” is “B department”” is stored in the second small area 1041.

The second data server 1005B is permitted to use the paths “third small area—second data server” and “fourth small area—second data server”. Further, the data whose “value of “/DOC/DATA/AUTHOR” is “A department”” is stored in the third small area 1042, while the data whose “value of “/DOC/DATA/AUTHOR” is “B department”” is stored in the fourth small area 1043.

It should be noted that the use of the two paths “second small area—second data server” and “third small area—first data server” is not permitted, and each small area is referenced by only one data server, causing no conflict or the like.

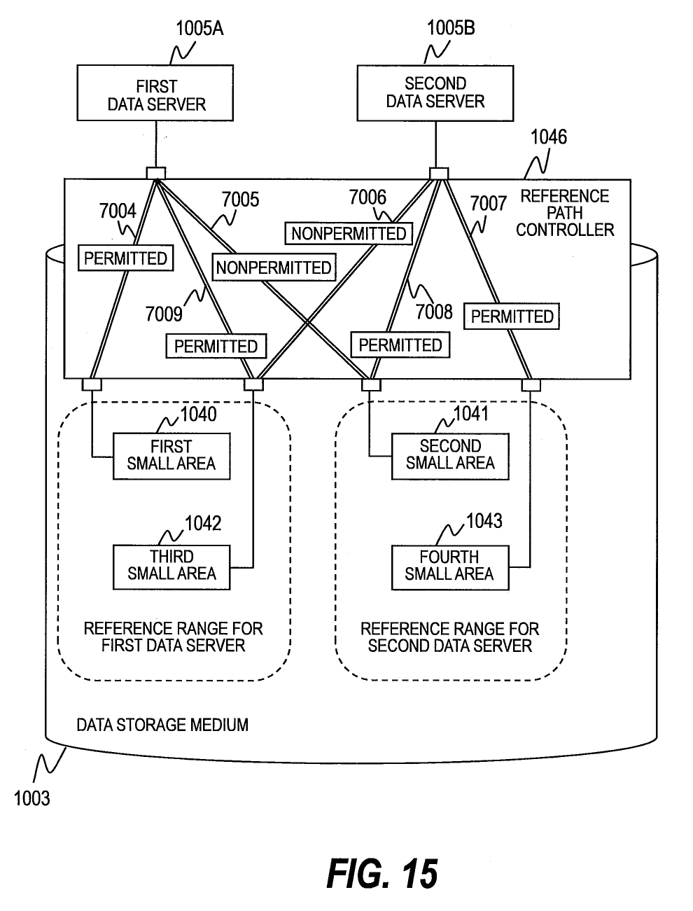

FIG. 15 is a diagram for explaining a state (management phase) after the end of the reference switch processing according to the first embodiment of this invention. Hereinbelow, description will be made of only differences from the storage phase before the start of the reference switch processing.

In the management phase, the first data server 1005A is permitted to use the paths “first small area—first data server” and “third small area—first data server”. The first data server 1005A manages the data whose “value of “/DOC/DATA/AUTHOR” is “A department”” stored in the first small area 1040 and the third small area 1042.

The second data server 1005B is permitted to use the paths “second small area—second data server” and “fourth small area—second data server”. The second data server 1005B manages the data whose “value of “/DOC/DATA/AUTHOR” is “B department”” stored in the second small area 1041 and the fourth small area 1043.

The use of the two paths “second small area—first data server” and “third small area—second data server” is not permitted, and each small area is referenced by only one data server, causing no conflict or the like.

Such a configuration as to limit the number of data servers referencing each data server constantly to one prevents occurrence of a conflict, and can realize a scalable parallel processing.

The first embodiment of this invention is useful particularly in a case of stopping a service using a parallel database system and ending the data loading in a short time.

According to the first embodiment of this invention, it is possible to reduce a time necessary for the data loading by switching the small area referenced by the data server 1005 between the areas referenced in the storage phase and the management phase.

To be specific, by switching the small area referenced by the data server 1005 between the areas referenced in the storage phase and the management phase, each small area is referenced by only one data server, which makes it easier to secure a parallel execution performance without causing a conflict. Further, it is not necessary to migrate data stored in the storage phase and the management phase, eliminating the cost of data migration, which allows simultaneous execution of the data analysis upon distribution and the data analysis upon storage. Therefore, it is possible to reduce the cost of analysis, and also possible to execute the data analysis upon distribution on each data server to thereby reduce a time necessary for the analysis.

It should be noted that the first embodiment of this invention has been described in terms of the method of deciding the distribution destination data servers 8101 in the data distribution processing so as to allocate data evenly to the respective data servers, but the data may be allocated randomly to the respective data servers or may be allocated based on a file creation time, a file name, or the like.

Further, the first embodiment of this invention has been described by taking the example of initial configuration from the state where no data is stored in the database, but may be applied to an operating database in which data has already been registered. To be specific, it is possible to add data by stopping a service of a database and changing the reference setting for every path over to the setting for the storage phase.

Further, the first embodiment of this invention has been described by taking the example of generating the index of the data registered in each data server at the timing when the phase is switched from the storage phase to the management phase, but the index may not necessarily be generated, and information supporting a search other than the index may be generated instead.

### Second Embodiment

The first embodiment of this invention has been described in terms of the method of stopping a service of a database to change the small area referenced by each data server 1005 in the storage phase and the management phase, but a second embodiment of this invention will be described in terms of a method of distributing data without stopping the service of the database.

A computer system according to the second embodiment has the same configuration as the computer system according to the first embodiment. The second embodiment differs from the first embodiment in the processings of the data loading control program 1014 stored in the data loading control server 1001 and the data storage management program 1036 stored in the data server 1005. It should be noted that the description of the same components and the same processings will be omitted.

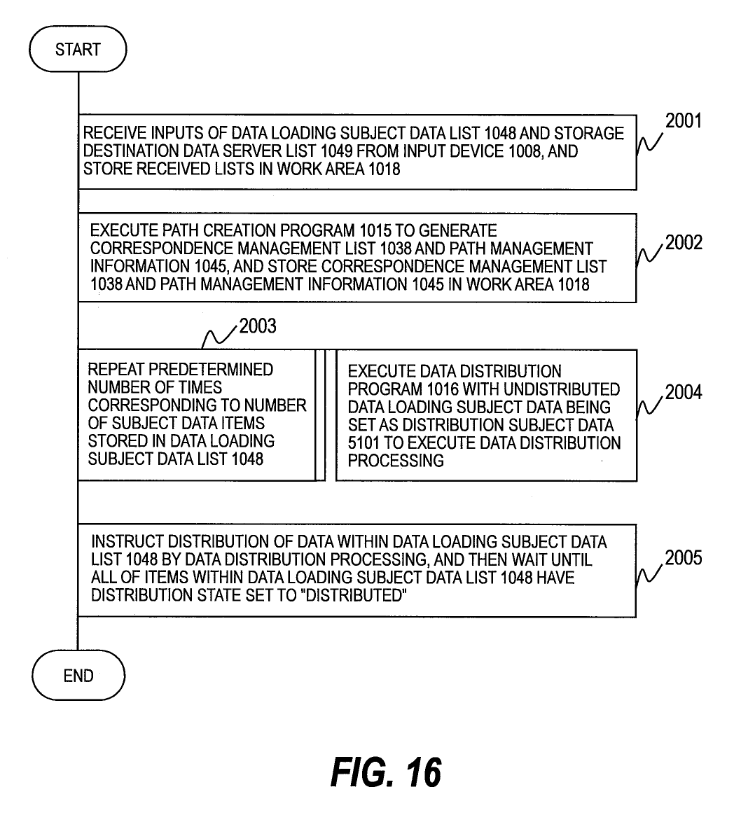

FIG. 16 is a PAD showing a procedure for a data loading processing according to the second embodiment of this invention.

The data loading processing according to the second embodiment differs from the data loading processing according to the first embodiment described with reference to FIG. 2 in that Steps 2006 to 2008 are not performed in the second embodiment because the switching is not performed between the storage phase and the management phase. The other steps are performed in the same manner as the first embodiment, so the description thereof will be omitted.

Next, description will be made of a storage management processing according to the second embodiment. In the same manner as in the first embodiment, the storage management processing according to the second embodiment is executed by processing the data storage management program 1036 when the data server 1005 receives the storage request signal 9102 from the original management control server 1002 in Step 9003 of FIG. 9.

According to the second embodiment of this invention, the storage management processing is further executed when an inter-data-server storage request signal 18101 is received from the data server 1005 that has received data other than its management subject data.

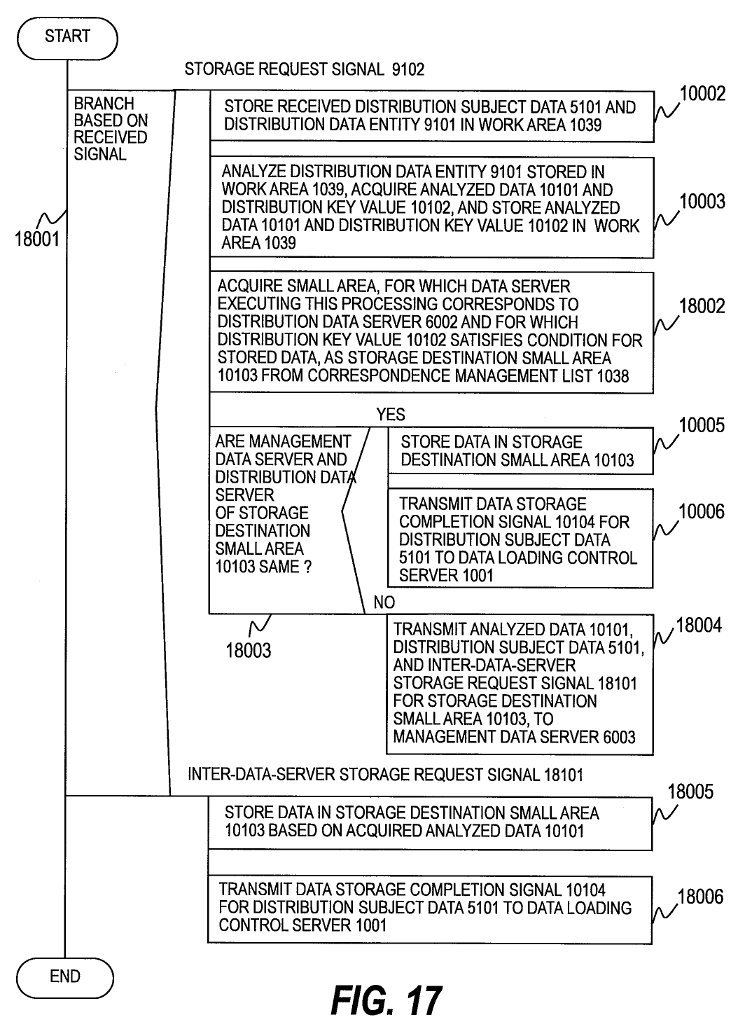

FIG. 17 is a PAD showing a procedure for the storage management processing according to the second embodiment of this invention.

The CPU 1029 of the data server 1005 branches the processing based on the received signal (Step 18001). To be specific, if the received signal is the storage request signal 9102, the data storage processing is executed. If the received signal is the inter-data-server storage request signal 18101, an inter-data-server storage request processing is executed.

In the data storage processing, in the same manner as the storage management processing according to the first embodiment described with reference to FIG. 10, the CPU 1029 of the data server 1005 stores the received information in the work area 1039, and analyzes the received distribution data entity 9101 (Steps 10002 and 10003).

Based on the analyzed data 10101, the CPU 1029 acquires the small area 6001, for which the data server 1005 executing this processing corresponds to the distribution data server 6002 and for which the acquired distribution key value 10102 satisfies the condition for stored data 6004, as the storage destination small area 10103 from the correspondence management list 1038 stored in the setting storage area 1037 (Step 18002).

The CPU 1029 branches the processing depending on whether or not the management data server 6003 of the storage destination small area 10103 is the same as the distribution data server 6002 thereof (Step 18003). If the management data server 6003 of the storage destination small area 10103 is the same as the distribution data server 6002 thereof (Step 18003 results in “Yes”), the CPU 1029 executes Steps 10005 and 10006 as executed in the storage management processing according to the first embodiment.

If the management data server 6003 of the storage destination small area 10103 differs from the distribution data server 6002 thereof (Step 18003 results in “No”), the CPU 1029 cannot store the distribution subject data 5101 in the storage destination small area 10103 in the management phase. Therefore, the CPU 1029 transmits the analyzed data 10101 and the distribution subject data 5101 along with the inter-data-server storage request signal 18101 for the storage destination small area 10103, to the management data server 6003 (Step 18004).

Based on the received analyzed data 10101, the CPU 1029 of the data server 1005 that has received the inter-data-server storage request signal 18101 stores the received distribution subject data 5101 in the storage destination small area 10103 of the data storage medium 1003 (Step 18005).

The CPU 1029 then transmits the data storage completion signal 10104 for the distribution subject data 5101 to the data loading control server 1001 (Step 18006).

In contrast to the first embodiment of this invention, in the second embodiment of this invention, data is migrated between the data servers, which necessitates the cost of data migration, but the data loading can be executed without stopping the service.

According to the second embodiment of this invention, it is possible to reduce the time necessary for the data loading by executing the analysis processing on the respective data servers in parallel. To be specific, by performing the analysis processing on the respective data servers in parallel, the data analysis upon distribution and the data analysis upon storage can be executed simultaneously at the time of distribution, which makes it possible to reduce the cost of analysis.

Further, the first embodiment of this invention may be applied upon the initial configuration of the system, while the second embodiment of this invention may be applied after the start of the system operation.

### Third Embodiment

The first and second embodiments of this invention have been described in terms of the method of executing the main control of the data loading processing by the data loading control server 1001, but the main control of the data loading processing may be executed by another server.

A third embodiment of this invention will be described in terms of a mode in which the main control of the data loading processing may be executed by the original management control server 1002.

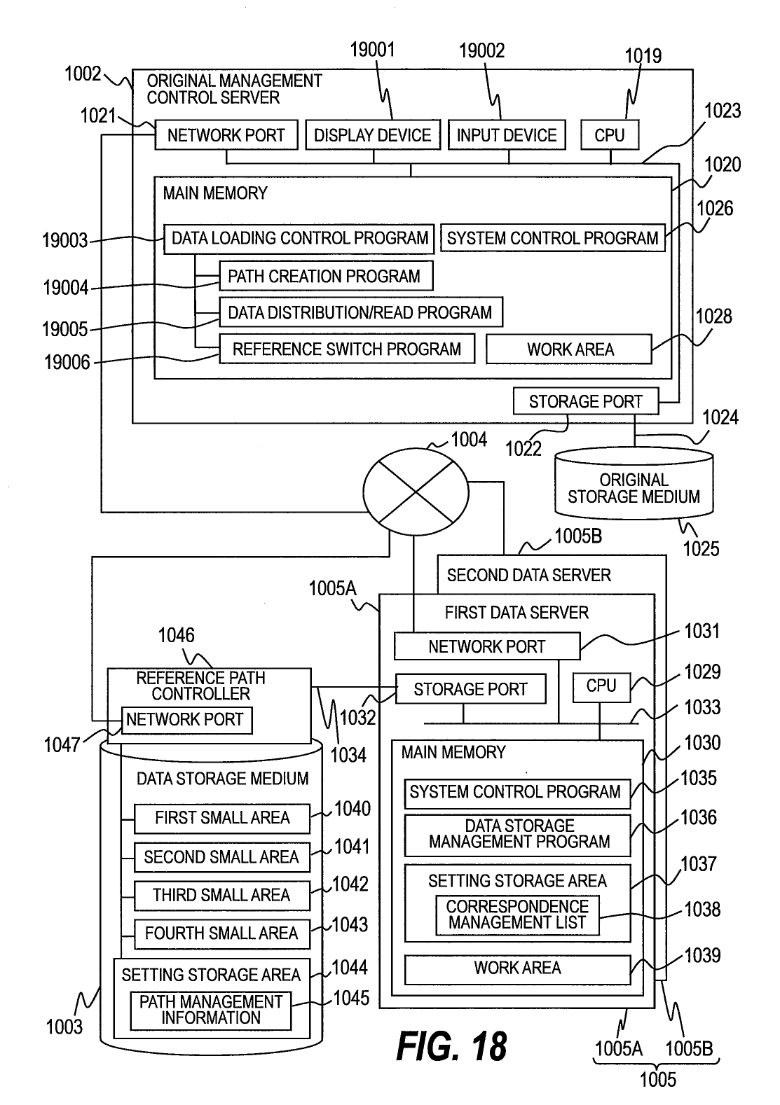

FIG. 18 is a diagram showing a configuration of a system including a parallel database according to the third embodiment of this invention. The system configuration of the third embodiment of this invention does not include the data loading control server 1001 as shown in FIG. 18.

The original management control server 1002 includes the display device 19001 and the input device 19002 in addition to the components of the first embodiment.

The display device 19001 displays results of various processings and the like in the same manner as the display device 1007 of FIG. 1 according to the first embodiment of this invention. The input device 19002 allows inputs of a command of an executed processing, information necessary therefor, and the like in the same manner as the input device 1008 of FIG. 1 according to the first embodiment of this invention.

The main memory 1020 of the original management control server 1002 additionally stores a data loading control program 19003, a path creation program 19004, a data distribution/read program 19005, and a reference switch program 19006.

The processing of each program of the third embodiment of this invention is the same as the corresponding processing of the first embodiment of this invention except that the inputs and display of information and the data loading control that are executed on the data loading control server 1001 are executed on the original management control server 1002 in the third embodiment.

Next, description will be made of a data distribution/acquisition processing executed by processing the data distribution/read program 19005 according to the third embodiment of this invention.

In the first embodiment of this invention, the data loading control server 1001 is provided separately from the original management control server 1002, making it necessary to exchange data between those servers. On the other hand, in the third embodiment of this invention, the processing executed by the data loading control server 1001 is executed by the original management control server 1002, which makes it unnecessary to perform communications between the data loading control server 1001 and the original management control server 1002. Therefore, the data distribution processing shown in FIG. 8 and the actual data acquisition processing shown in FIG. 9 of the first embodiment can be combined to a series of processings.

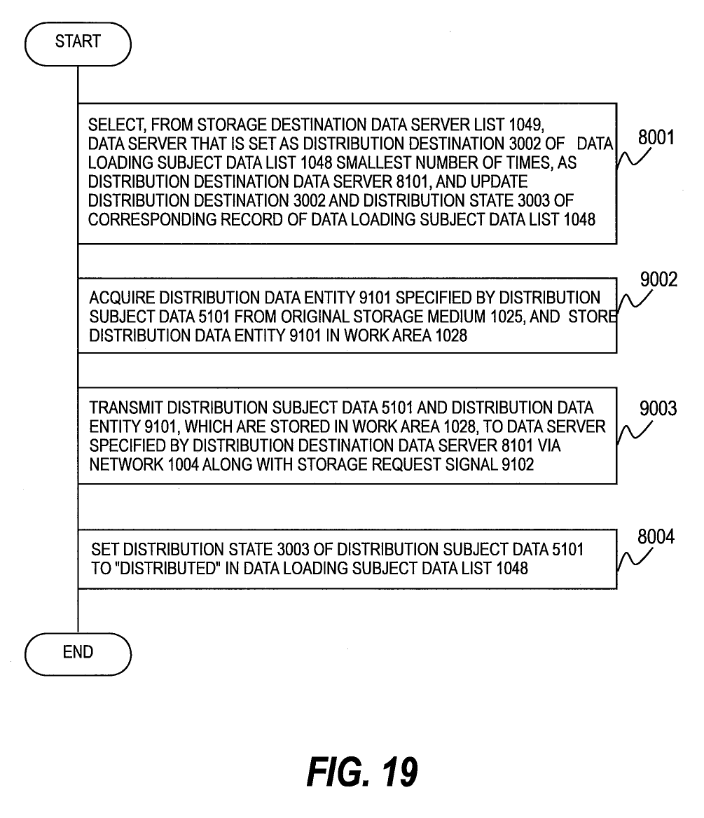

FIG. 19 is a PAD showing a procedure for the data distribution/acquisition processing according to the third embodiment of this invention.

The CPU 1019 of the original management control server 1002 first selects, from the storage destination data server list 1049, one data server that is set as the distribution destination 3002 of the data loading subject data list 1048 the smallest number of times, as the distribution destination data server 8101. The CPU 1019 then sets the selected distribution destination data server 8101 in the data loading subject data list 1048 as the distribution destination 3002 for the distribution subject data 5101 (Step 8001). The CPU 1019 further sets the distribution state 3003 of the data loading subject data list 1048 to the value “undistributed”.

The CPU 1019 acquires the distribution data entity 9101 specified by the distribution subject data 5101 from the original storage medium 1025, and stores the distribution data entity 9101 in the work area 1028 (Step 9002).

The CPU 1019 transmits the distribution subject data 5101 and the distribution data entity 9101, which are stored in the work area 1028, to a data server specified by the distribution destination data server 8101 via the network 1004 along with the storage request signal 9102 (Step 9003).

The CPU 1019 sets the distribution state 3003 of the distribution subject data 5101 to “distributed” in the data loading subject data list 1048 (Step 8004). After Step 8004 is complete, the data distribution/acquisition processing comes to an end.

Next, the storage management processing is executed. In the same manner as the first embodiment of this invention, the storage management processing is executed by processing the data storage management program 1036 when the data server 1005 receives the storage request signal 9102 from the original management control server 1002. The storage management processing is also executed by the data storage management program 1036 processed when the data server 1005 receives the phase change signal 13101 from the original management control server 1002.

The storage management processing by the data storage management program 1036 is executed in the same manner as the first embodiment except that the server to which the signals are transmitted in Steps 10006 and 10009 of FIG. 10 is the original management control server 1002 instead of the data loading control server 1001.

The reference switch processing by the reference switch program 19006 is executed in the same manner as the reference switch processing described with reference to FIG. 13 except that the reference switch program 19006 is executed by the original management control server 1002 instead of the data loading control server 1001.

The third embodiment of this invention is useful in a case of stopping a service using a parallel database system and ending the data loading in a short time without using the data loading control server 1001.

According to the third embodiment of this invention, in the same manner as the first embodiment of this invention, it is possible to reduce the time necessary for the data loading by switching the small area referenced by the data server between the areas referenced in the storage phase and the management phase without using the data loading control server 1001.

Further, according to the third embodiment of this invention, it is possible to reduce the number of necessary servers by eliminating the use of the data loading control server, thereby reducing an investment in equipment.

Further, the third embodiment of this invention has been described in terms of the method of executing the main control of the data loading processing by the original management control server 1002, but the main control of the data loading processing may be executed by one of the data servers.

### Fourth Embodiment

The first to third embodiments of this invention have been described in terms of the method of managing such a state that the path between each data server and each small area is permitted or nonpermitted by using the function of the data storage medium, but a method of controlling the reference to the small area by each data server may be employed.

A computer system according to a fourth embodiment of this invention has the same configuration as the computer system according to the first embodiment except that the data loading control program 1014 stored in the data loading control server 1001 and the data storage management program 1036 stored in the data server 1005 are processed in different manners.

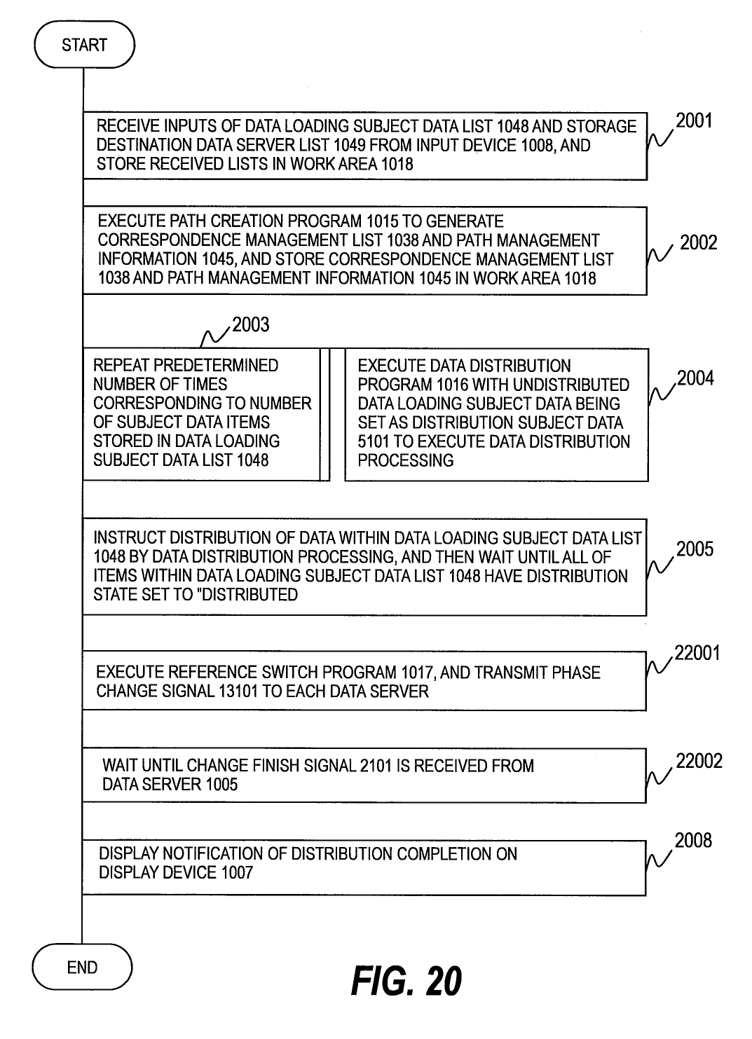

FIG. 20 is a PAD showing a procedure for a data loading processing according to the fourth embodiment of this invention.

In the same manner as the data loading processing according to the first embodiment, the CPU 1009 of the data loading control server 1001 receives inputs of the data loading subject data list 1048 and the storage destination data server list 1049 from the input device 1008 (Step 2001).

In the same manner as the first embodiment, the CPU 1009 activates the path creation program 1015 to perform the path creation processing of generating the correspondence management list 1038 and the path management information 1045 (Step 2002).

In the same manner as the first embodiment, the CPU 1009 executes the data distribution processing on the data stored in the data loading subject data list 1048 (Steps 2003 and 2004). Then, the CPU 1009 waits until the data has been stored on each data server (Step 2005).

The CPU 1009 activates the reference switch program 1017 to transmit the phase change signal 13101 to each data server (Step 22001). In the first embodiment, the phase is switched by transmitting the phase change signal 13101 to the reference path controller 1046 (Step 2006 of FIG. 2), but in the fourth embodiment, the phase change signal 13101 only has to be transmitted to each data server because the reference to each small area is controlled by each data server.

The CPU 1009 waits until the change finish signal 2101 is received from the data server 1005 (Step 22002), and displays a notification of distribution completion on the display device 1007 (Step 2008).

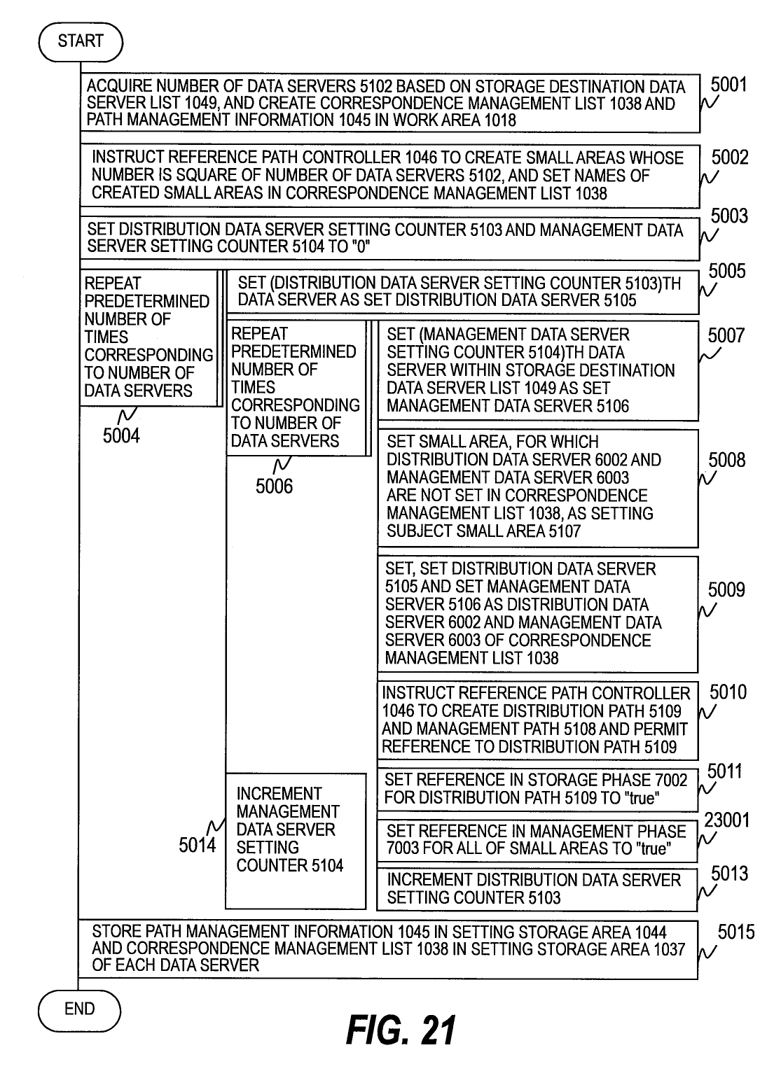

FIG. 21 is a PAD showing a procedure for the path creation processing according to the fourth embodiment of this invention. The outline of the processing is substantially the same as the first embodiment.

In the fourth embodiment, the reference to each small area is controlled by each data server, so the reference path controller 1046 permits the use of all the paths to each small area of the data storage medium 1003. On the other hand, in the first embodiment, the path management information 1045 is set so that the reference is allowed only to the small area to be managed by the data server 1005 (Step 5012 of FIG. 5), but in the fourth embodiment, the reference in the management phase for all of the small areas is set to be possible (Step 23001).

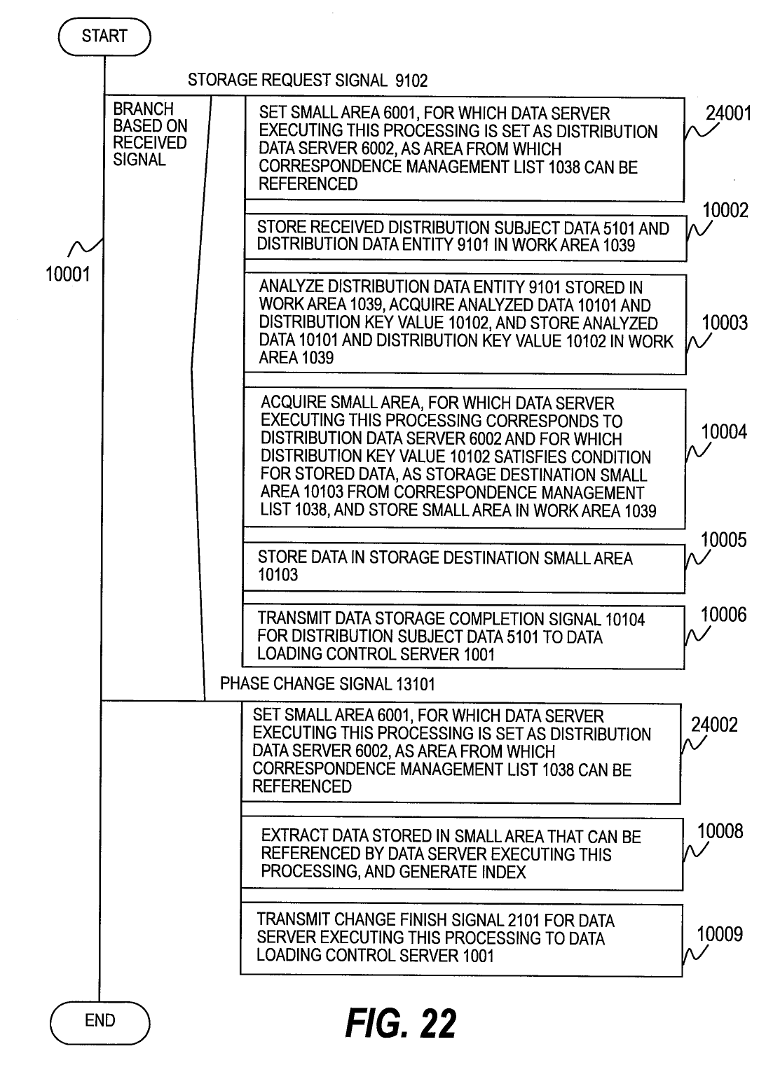

FIG. 22 is a PAD showing a procedure for a storage management processing according to the fourth embodiment of this invention.

In the same manner as the storage management processing according to the first embodiment, the CPU 1029 of the data server 1005 executes a data storage processing or a phase change processing based on the received signal (Step 10001).

At the start of the data storage processing or the phase change processing, the CPU 1029 sets the small area 6001, for which the data server 1005 executing this processing is set as the distribution data server 6002, as an area from which the correspondence management list 1038 can be referenced (Step 24001 or 24002). The steps subsequent to Steps 24001 and 24002 are the same as those of the data storage processing and the phase change processing of the first embodiment, respectively.

In the fourth embodiment, the reference to each small area is controlled by each data server, so Steps 24001 and 24002 are executed.

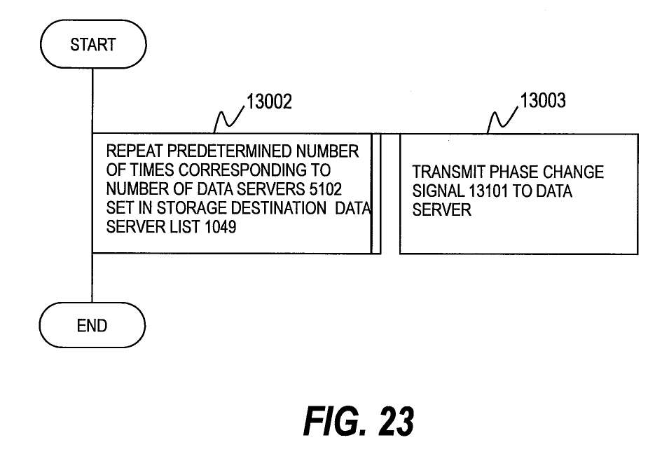

FIG. 23 is a PAD showing a procedure for a reference switch processing according to the fourth embodiment of this invention.

In the reference switch processing according to the fourth embodiment, the reference to each small area is controlled by each data server, which eliminates the need for transmitting the phase change signal 13101 to the reference path controller 1046. Therefore, the reference switch processing according to the fourth embodiment of this invention differs from the reference switch processing according to the first embodiment shown in FIG. 13 in that Step 13001 does not exist in the fourth embodiment.

The fourth embodiment of this invention is useful in a case of ending the data loading in a short time without depending on the function of the data storage medium 1003.

The fourth embodiment of this invention has been described by using the data storage medium 1003 including the reference path controller 1046 as the data storage destination, but may be described by using a data storage medium that excludes the reference path controller 1046 and can be referenced by a plurality of servers, such as a network attached storage (NAS) that does not have the reference path controller 1046. In this case, the data server 1005 or the like needs to execute the processing that has been executed by instructing the reference path controller 1046.

According to the fourth embodiment of this invention, it is possible to reduce the time necessary for the data loading by switching the small area referenced by each data server between the areas referenced in the storage phase and the management phase without depending on the function of the data storage medium 1003.

To be specific, each data server controls the reference to each small area, which makes it possible to switch the small area referenced by each data server between the areas referenced in the storage phase and the management phase without depending on the function of the data storage medium 1003, thereby producing the same effect as the first embodiment.

### Fifth Embodiment

The first to fourth embodiments of this invention have been described in terms of the method in which the data server operates on physically independent hardware, but the data server may be a virtual server implemented by a virtualization function.

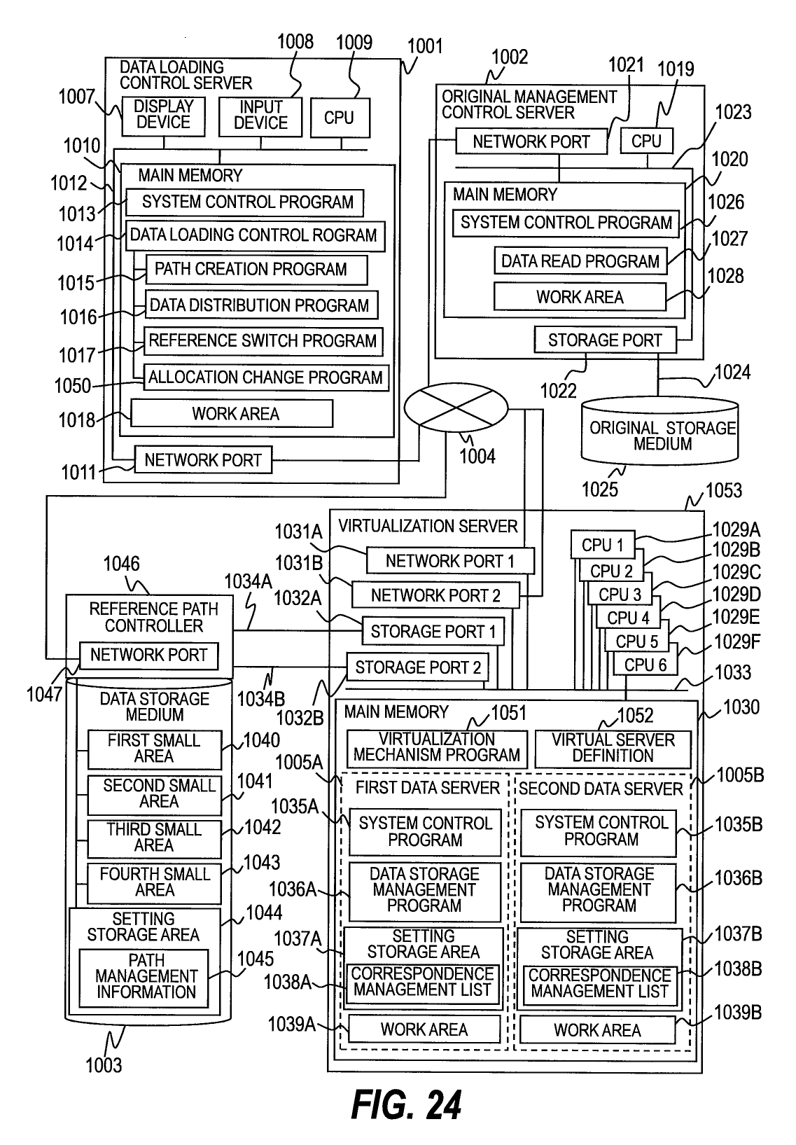

FIG. 24 is a diagram showing a configuration of a system including a parallel database according to a fifth embodiment of this invention.

The system includes the data loading control server 1001, the original management control server 1002, the data storage medium 1003, and a virtualization server 1053. The original management control server 1002 and the data storage medium 1003 are the same as those of the computer system according to the first embodiment.

The virtualization server 1053 includes CPUs 1 to 6 (1029A to 1029F), the main memory 1030, a network port 1 (1031A), a network port 2 (1031B), a storage port 1 (1032A), and a storage port 2 (1032B).

The CPUs 1 to 6 (1029A to 1029F), the main memory 1030, the network port 1 (1031A), the network port 2 (1031B), the storage port 1 (1032A), and the storage port 2 (1032B) are coupled to one another.

The CPUs 1 to 6 (1029A to 1029F) each execute a program stored in the main memory 1030 to execute a predetermined processing. The main memory 1030 stores the program executed by the CPUs 1 to 6 (1029A to 1029F) and data necessary for execution of the program.

The main memory 1030 stores a virtualization mechanism program 1051 and a virtual server definition 1052.

The virtualization mechanism program 1051 is executed by the CPU to divide computer resources for the virtualization server 1053 in logical units, thereby implementing at least one virtual server. To be specific, the computer resources for the virtualization server 1053 correspond to the CPUs 1 to 6 (1029A to 1029F), the main memory 1030, the network port 1 (1031A), the network port 2 (1031B), the storage port 1 (1032A), and the storage port 2 (1032B). The virtualization mechanism program 1051 also controls allocation of the computer resources to be allocated to the virtual server.

The virtual server definition 1052 contains a correspondence between the virtual server implemented by the virtualization mechanism program 1051 and the computer resources allocated to the virtual server. The virtualization mechanism program 1051 implements the virtual server based on the virtual server definition 1052.

The virtual server implemented by the virtualization mechanism program 1051 operates as one independent hardware component. In the virtualization server 1053 of FIG. 24, the first data server 1005A and the second data server 1005B are implemented as the virtual servers. The first data server 1005A includes the network port 1 (1031A), the storage port 1 (1032A), and the CPUs 1 to 3 (1029A to 1029C). The second data server 1005B includes the network port 2 (1031B), the storage port 2 (1032B), and the CPUs 4 to 6 (1029D to 1029F).

A main memory of the first data server 1005A stores a system control program 1035A and a data storage management program 1036A. The main memory of the first data server 1005A also includes a setting storage area 1037A and a work area 1039A. The programs stored in the main memory of the first data server 1005A are executed by the CPUs 1 to 3 (1029A to 1029C) to execute predetermined processings.

The system control program 1035A executes the predetermined processing based on the control signal received from an external component or the state of the first data server 1005A.

The data storage management program 1036A analyzes the distribution data entity 9101, and decides which data server (virtual server) is to manage the data based on the analysis results and the correspondence relationships between data servers and small areas. The data storage management program 1036A stores the data in the small area managed by the decided data server in the management phase.

Stored in the setting storage area 1037A is a correspondence management list 1038A. The correspondence management list 1038A stores correspondence relationships between the data servers and the small areas secured in the data storage medium 1003.

A main memory of the second data server 1005B stores a system control program 1035B and a data storage management program 1036B. The main memory of the second data server 1005B also includes a setting storage area 1037B and a work area 1039B. The programs stored in the main memory of the second data server 1005B are executed by the CPUs 4 to 6 (1029D to 1029F) to execute predetermined processings.

The system control program 1035B executes the predetermined processing based on the control signal received from an external component or the state of the second data server 1005B.

The data storage management program 1036B analyzes the distribution data entity 9101, and decides which data server (virtual server) is to manage the data based on the analysis results and the correspondence relationships between data servers and small areas. The data storage management program 1036B stores the data in the small area managed by the decided data server in the management phase.

Stored in the setting storage area 1037B is a correspondence management list 1038B. The correspondence management list 1038B stores correspondence relationships between the data servers and the small areas secured in the data storage medium 1003.

It should be noted that the two data servers are implemented as the first data server 1005A and the second data server 1005B in the fifth embodiment of this invention, but may be changed depending on the system configuration.

Further, the fifth embodiment of this invention has been described in terms of the method of allocating the CPUs to the virtual servers in a fixed manner, but may be described in terms of a method of dynamically allocating the CPUs in a predetermined proportion instead of allocating the specific CPUs to the virtual servers.

The data loading control program 1014 stored in the main memory 1010 of the data loading control server 1001 further includes the allocation change program 1050.

The allocation change program 1050 is executed by the CPU 1009 to decide the allocation of the computer resources to each data server (virtual server) based on a processing executed on the virtualization server 1053 or a data amount of data referenced by the data server (virtual server), and instructs the virtualization server 1053 to change the current allocation to the decided allocation. The virtualization server 1053 reallocates the computer resources of the respective virtual servers based on the received instruction by the processing of the virtualization mechanism program 1051.

Next, description will be made of the processing according to the fifth embodiment of this invention.

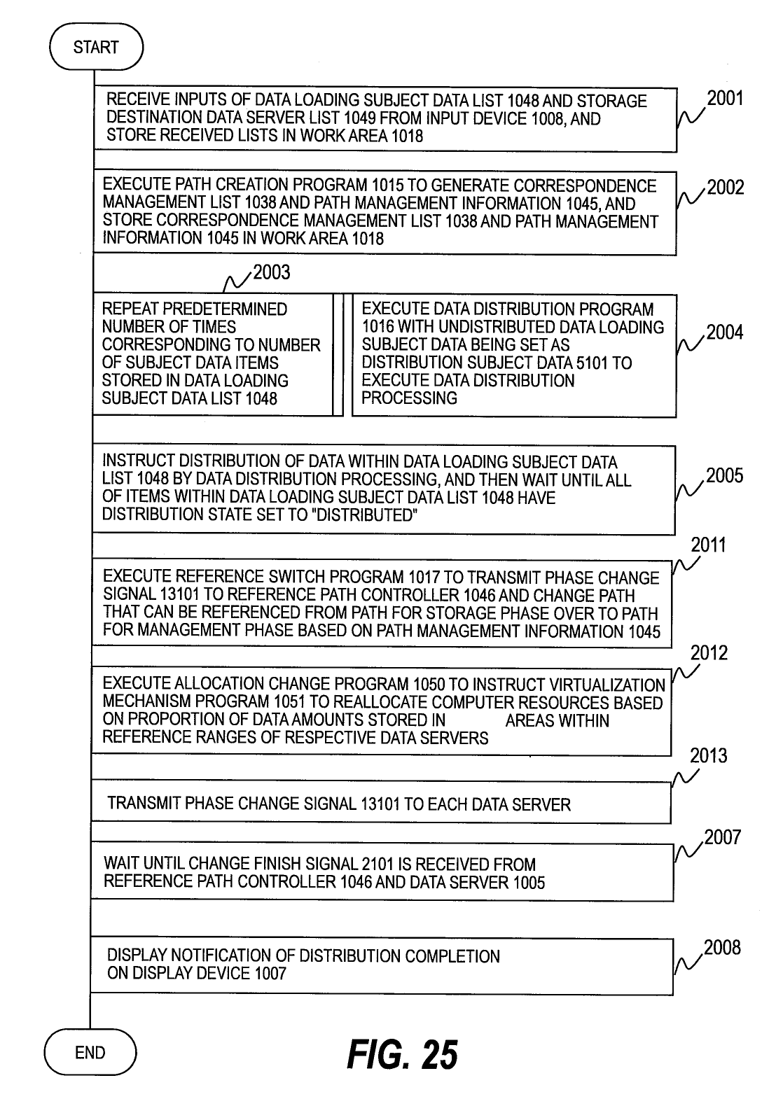

FIG. 25 is a PAD showing a procedure for a data loading processing according to the fifth embodiment of this invention.

The CPU 1009 of the data loading control server 1001 processes the data loading control program 1014 to execute the data loading processing.

Steps 2001 to 2005 are the same as those of the data loading processing according to the first embodiment described with reference to FIG. 2.

After all of the distribution states 3003 of the data loading subject data list 1048 are set to “distributed”, the CPU 1009 processes the reference switch program 1017 to execute the reference switch processing (Step 2011). In the reference switch processing, the CPU 1009 transmits the phase change signal 13101 to the reference path controller 1046 of the data storage medium 1003, and changes a path that can be referenced from a path for the storage phase over to a path for the management phase based on the path management information 1045. The procedure for the reference switch processing is the same as that of the first embodiment shown in FIG. 13.

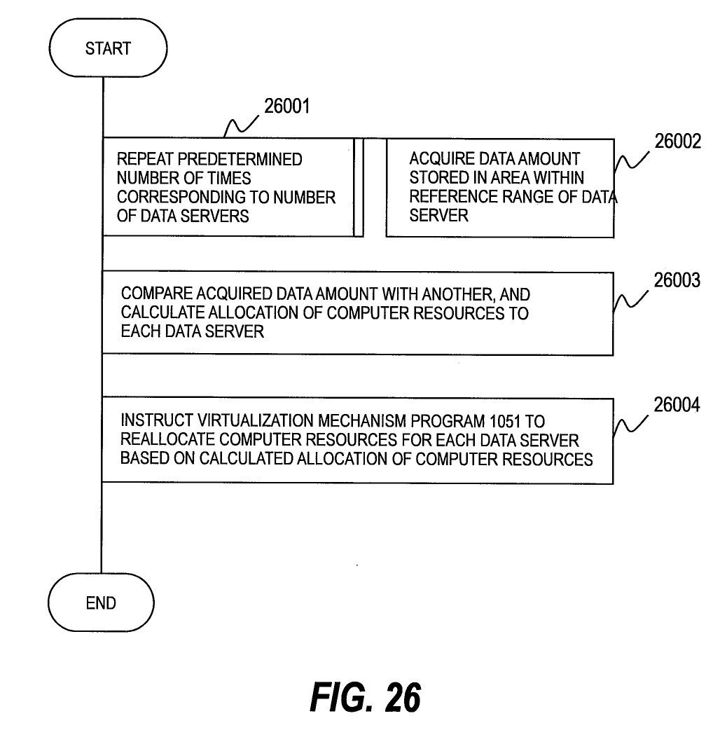

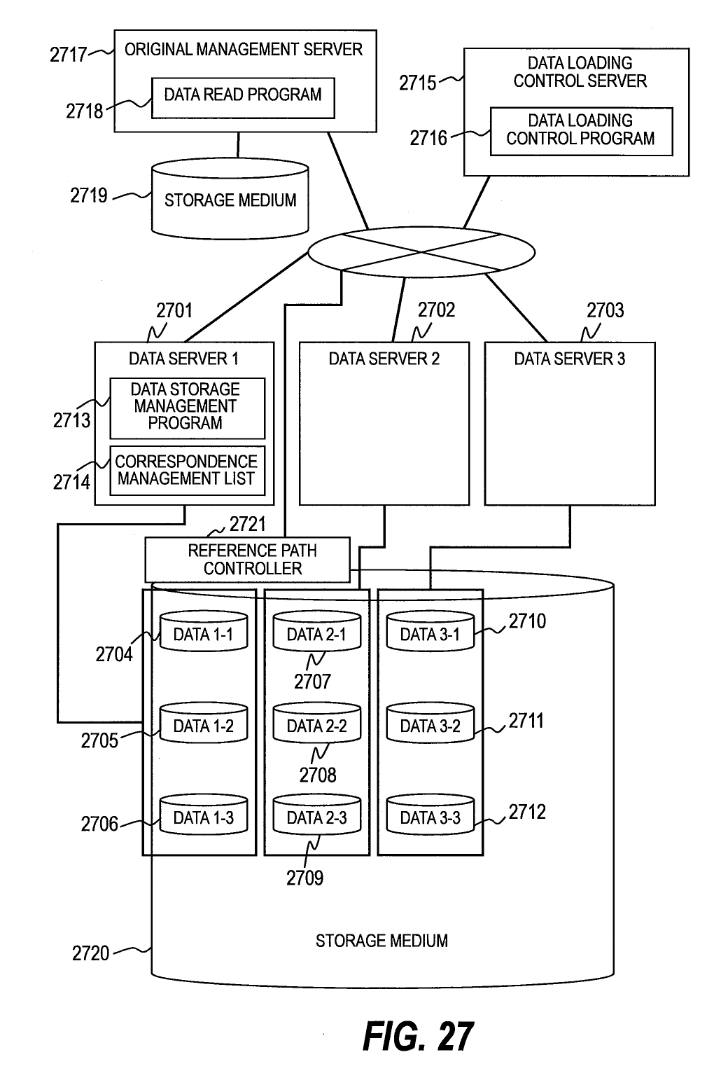

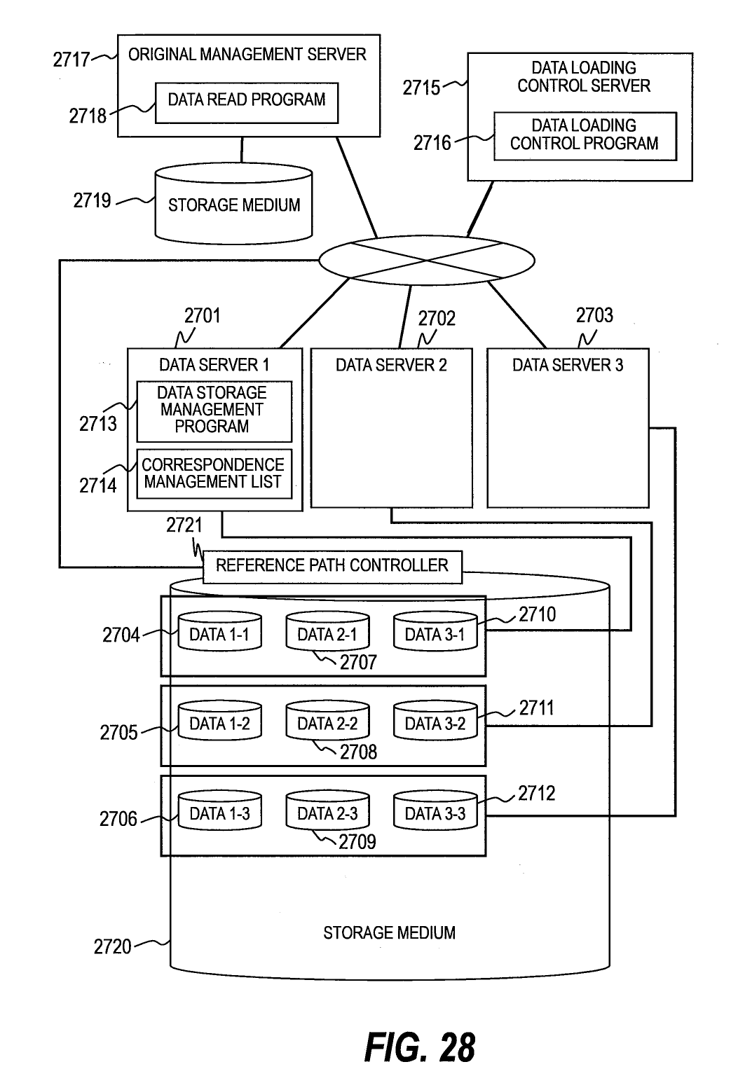

The CPU 1009 executes the allocation change program 1050 to instruct the virtualization mechanism program 1051 to reallocate the computer resources based on the proportion of data amounts of data stored in areas within reference ranges of the respective data servers (Step 2012). A procedure for an allocation change processing for the computer resources will be described later with reference to FIG. 26.

The CPU 1009 transmits the phase change signal 13101 to each data server (Step 2013).

The CPU 1009 waits until the change finish signal 2101 is received from the reference path controller 1046 of the data storage medium 1003 and from each data server (Step 2007).

Upon reception of the change finish signal 2101 from every data server, the CPU 1009 displays a notification of distribution completion on the display device 1007 (Step 2008). After the end of Step 2008, the data loading processing comes to an end.

FIG. 26 is a PAD showing the procedure for the allocation change processing for the computer resources in the virtualization server 1053 according to the fifth embodiment of this invention.

The CPU 1009 acquires the data amount of data stored in the area within the reference range of each data server (Steps 26001 and 26002).

To be specific, the CPU 1009 acquires a data amount of the data distributed to each data server by the data distribution processing, and further acquires a data amount of the data stored in the respective small areas within a reference range of each data server. For example, in the state shown in FIG. 15 after the phase is changed from the management phase to the storage phase, the data amount of the data stored in the first small area and the data stored in the third small area is acquired for the first data server 1005A, while the data amount of the data stored in the second small area and the data stored in the fourth small area is acquired for the second data server 1005B.

The CPU 1009 compares the acquired data amount with another, and calculates the allocation of the computer resources to each data server (Step 26003).

Subjects by which the computer resources are to be allocated are the number of CPUs allocated to virtual servers and the size of the main memory 1030 allocated to the virtual servers. The allocation is calculated based on the proportion of the data amounts obtained by acquiring those values.

For example, if the data amounts are substantially the same, the same number of CPUs and the same memory size is allocated to each virtual server without any change of the proportion. If the data amount for the first data server 1005A differs from the data amount for the second data server 1005B, the numbers of CPUs and the memory sizes are changed based on the proportion of the data amounts. For example, the proportion of the data amounts is 4:2, the allocation of the 6 CPUs is changed from “3 CPUs and 3 CPUs” to “4 CPUs and 2 CPUs”.

The CPU 1009 instructs the virtualization server 1053 to reallocate the computer resources for each virtual server based on the allocation of the computer resources calculated in Step 26003 (Step 26004).

Upon reception of an instruction from the data loading control server 1001, the virtualization server 1053 processes the virtualization mechanism program 1051 to reallocate the computer resources for each virtual server. If such an instruction as described above to change the allocation of the CPUs to “4 CPUs and 2 CPUs”, the CPUs 1 to 4 (1029A to 1029D) are allocated to the first data server 1005A, while the CPUs 5 and 6 (1029E and 1029F) are allocated to the second data server 1005B.

According to the fifth embodiment of this invention, the data servers (virtual servers) are implemented on the virtualization server, and the computer resources are reallocated in each phase, thereby making it possible to simulate equalized loads on the computer resources. To be specific, the computer resources are allocated to the respective data servers approximately evenly upon execution of the data distribution processing, and after the data distribution processing, the computer resources are allocated to the respective data servers based on the data amounts of the data distributed to the respective data servers in the storage phase. Accordingly, even if the allocation of the data amounts of the data distributed in the storage phase is biased among the respective data servers, the load on the computer resources per unit data amount can be equalized across the entire system.

It should be noted that in the fifth embodiment of this invention, the allocation of the computer resources to each data server is changed based on the data amounts, but the allocation of the computer resources to each data server may be changed based on amounts of the loads on the respective data servers after the service of the database is started.

While the present invention has been described in detail and pictorially in the accompanying drawings, the present invention is not limited to such detail but covers various obvious modifications and equivalent arrangements, which fall within the purview of the appended claims.

What is claimed is:

1. A data management method for managing data stored in a parallel database system in which a plurality of data servers manage data,
the parallel database system managing: correspondence information between a characteristic of the data and each of the plurality of data servers that manages the data; and a data area corresponding to the characteristic of the data,
the data management method comprising the steps of:
extracting the characteristic of the data from data to be stored in the data area;
storing the data in the data area based on the extracted characteristic of the data;
specifying a corresponding data area based on the characteristic of the data stored in the data area by referring to the correspondence information; and
accessing, by each of the plurality of data servers, the specified data area.

2. The data management method according to claim 1, further comprising the steps of:
setting the data area to be accessible by the each of the plurality of data servers corresponding to the data area, after storing the data in the data area; and
acquiring, by the data server corresponding to the characteristic of data to be acquired, the data from the data area set to be accessible by the data server.

3. The data management method according to claim 1, wherein:
the parallel database system has a virtualization module for logically dividing computer resources including a processor to provide a plurality of virtual computers;
the plurality of data servers are operated on the plurality of virtual computers provided by the virtualization module; and
the data management method further comprises the step of instructing the virtualization module to allocate the computer resources to the plurality of virtual computers on which the plurality of data servers are operated.

4. A data management method for distributing data to a storage device managed by a plurality of data servers in a parallel database system in which the plurality of data servers manage data,
the parallel database system having: a first storage system for storing source data; a second storage system for storing the data distributed from the first storage system, which is accessed by the plurality of data servers; the plurality of data servers; and a management server coupled to the plurality of data servers via a network,
the management server having: a first interface coupled to the network; a first processor coupled to the first interface; and a first memory accessed by the first processor,
the plurality of data servers each having: a second interface coupled to the network; a second processor coupled to the second interface; and a second memory accessed by the second processor,
the second memory storing correspondence information between a characteristic of the data and each of the plurality of data servers that manages the data,
the second storage system providing each of the plurality of data servers with a storage area for storing the data distributed from the first storage system,
the data management method comprising the steps of:
creating, by the second processor, a data area corresponding to be accessible by each of the plurality of data servers in the storage area;
transmitting, by the first processor, the source data from the first storage system to the plurality of data servers;
receiving, by the second processor, the data transmitted from the first storage system;
analyzing, by the second processor, the received data to extract the characteristic of the received data;
specifying, by the second processor, one of the plurality of data servers that manages the received data based on the extracted characteristic of the data by referring the correspondence information;
storing, by the second processor, the received data in the data area which is accessible by the data server that has received the data transmitted from the first storage system and which corresponds to the specified one of the plurality of data servers; and
setting, by the first processor, the data area corresponding to the specified one of the plurality of data servers to be accessible by the specified one of the plurality of data servers.

5. The data management method according to claim 4, wherein:
the data includes a document described in a document language in which an element is defined; and
the data management method further comprises the step of analyzing, by the second processor, the received data to extract, from the received data, the element corresponding to the characteristic of the data, the characteristic included in the correspondence information.

6. The data management method according to claim 4, further comprising the steps of:
transmitting, by the first processor the source data from the first storage system to the plurality of data servers in the case of which data is further to be distributed after the data area corresponding to the specified one of the plurality of data servers is set to be accessible by the specified one of the plurality of data servers;
receiving, by the second processor, the data transmitted from the first storage system;
analyzing, by the second processor, the received data to extract the characteristic of the received data;
specifying, by the second processor, one of the plurality of data servers that manages the received data based on the extracted characteristic of the data and the correspondence information;
judging, by the second processor, whether the data server that has received the data transmitted from the first storage system is the same as the specified one of the plurality of data servers;
storing, by the second processor, the received data in the data area in the case of which the data server that has received the data transmitted from the first storage system is the same as the specified one of the plurality of data servers; and
transmitting, by the second processor, the received data to the specified one of the plurality of data servers in the case of which the data server that has received the data transmitted from the first storage system is not the same as the specified one of the plurality of data servers.

7. The data management method according to claim 4, further comprising creating, by the second processor, an index of the data stored in the data area after the data area corresponding to the specified one of the plurality of data servers is set to be accessible by the specified one of the plurality of data servers.

8. A parallel database system, comprising:
a plurality of data servers for managing data;
a first storage system for storing source data;
a second storage system for storing the data distributed from the first storage system, which is accessed by the plurality of data servers; and
a management server coupled to the plurality of data servers via a network,
the management server comprising: a first interface coupled to the network; a first processor coupled to the first interface; and a first memory accessed by the first processor,
the plurality of data servers each comprising: a second interface coupled to the network; a second processor coupled to the second interface; and a second memory accessed by the second processor,
the second memory storing correspondence information between a characteristic of the data and each of the plurality of data servers that manages the data,
the second storage system providing each of the plurality of data servers with a storage area for storing the data distributed from the first storage system, wherein:
the each of the plurality of data servers is configured to create a data area corresponding to the each of the plurality of data servers in the storage area of the each of the plurality of data servers;
the management server is configured to transmit the source data from the first storage system to the plurality of data servers;
each of the plurality of data servers is configured to:
receive the data transmitted from the first storage system;
analyze the received data to extract the characteristic of the received data;
specify one of the plurality of data servers that manages the received data based on the extracted characteristic of the data by referring to the correspondence information; and
store the received data in the data area which is accessible by the data server that has received the data transmitted from the first storage system and which corresponds to the specified one of the plurality of data servers; and
the management server is configured to set the data area corresponding to the specified one of the plurality of data servers to be accessible by the specified one of the plurality of data servers.

9. The parallel database system according to claim 8, wherein:
the data includes a document described in a document language in which an element is defined; and
the plurality of data servers each are configured to analyze the received data to extract, from the received data, the element corresponding to the characteristic of the data, the characteristic included in the correspondence information.

10. The parallel database system according to claim 8, wherein:
the management server is configured to transmit the source data from the first storage system to the plurality of data servers in the case of which data is further to be distributed after the data area corresponding to the specified one of the plurality of data servers is set to be accessible by the specified one of the plurality of data servers; and
each of the plurality of data servers is configured to:
receive the data transmitted from the first storage system;
analyze the received data to extract the characteristic of the received data;
specify one of the plurality of data servers that manages the received data based on the extracted characteristic of the data and the correspondence information;
judge whether the data server that has received the data transmitted from the first storage system is the same as the specified one of the plurality of data servers;
store the received data in the data area in the case of which the data server that has received the data transmitted from the first storage system is the same as the specified one of the plurality of data servers; and
transmit the received data to the specified one of the plurality of data servers in the case of which the data server that has received the data transmitted from the first storage system is not the same as the specified one of the plurality of data servers.

11. The parallel database system according to claim 8, wherein each of the plurality of data servers is configured to create an index of the data stored in the data area after the data area corresponding to the specified one of the plurality of data servers is set to be accessible by the specified one of the plurality of data servers.

12. The parallel database system according to claim 8, wherein:
the second storage system comprises a reference controller for controlling access from the plurality of data servers; and
the reference controller is configured to set a data area accessed by the plurality of data servers upon reception of an instruction from the management server.

13. The parallel database system according to claim 8, wherein each of the plurality of data servers is configured to set a data area accessed by the each of the plurality of data servers upon reception of an instruction from the management server.

14. A data management method for distributing data to a storage system managed by a plurality of data servers in a parallel database system in which the plurality of data servers manage data,
the parallel database system having: a first storage system for storing source data; a second storage system for storing the data distributed from the first storage system, which is accessed by the plurality of data servers; a management server coupled to the plurality of data servers via a network; and a virtualization module for providing a plurality of virtual computers,
the management server having: a first interface coupled to the network; a first processor coupled to the first interface; and a first memory accessed by the first processor,
the virtualization module having computer resources including: a second interface coupled to the network; a second processor coupled to the second interface; and a second memory accessed by the second processor,
the virtualization module providing the plurality of virtual computers by logically dividing the computer resources,
the plurality of data servers being operated on the plurality of virtual computers provided by the virtualization module,
the plurality of virtual computers each storing correspondence information between a characteristic of the data and each of the plurality of data servers that manages the data,
the second storage device providing each of the plurality of data servers with a storage area for storing the data distributed from the first storage device,
the data management method comprising the steps of:
creating, by the second processor, a data area corresponding to each of the plurality of data servers in the storage area of the each of the plurality of data servers;
instructing the virtualization module to allocate the computer resources to the plurality of virtual computers on which the plurality of data servers are operated;
transmitting, by the first processor, the source data from the first storage device to the plurality of data servers;
receiving, by the second processor, the data transmitted from the first storage device;
analyzing, by the second processor, the received data to extract the characteristic of the received data;
specifying, by the second processor, one of the plurality of data servers that manages the received data based on the extracted characteristic of the data by referring to the correspondence information;
storing, by the second processor, the received data in the data area which is accessible by the data server that has received the data transmitted from the first storage device and which corresponds to the specified one of the plurality of data servers; and
setting, by the first processor, the data area corresponding to the specified one of the plurality of data servers to be accessible by the specified one of the plurality of data servers.

15. The data management method according to claim 14, further comprising the step of instructing, by the first processor, after the data has been distributed, the virtualization module to allocate the computer resources to the plurality of virtual computers on which the plurality of data servers are operated based on amounts of data processed by the plurality of data servers.

16. The data management method according to claim 14, further comprising instructing, by the first processor, after the data has been distributed, the virtualization module to allocate the computer resources to the plurality of virtual computers on which the plurality of data servers are operated based on amounts of data stored in the data area.
